(19) United States
(12) Patent Application Publication
(10) Pub. No.: US 2018/0043663 A1
(43) Pub. Date: Feb. 15, 2018

(54) OPTICAL LAMINATE, POLARIZING PLATE AND LIQUID CRYSTAL DISPLAY DEVICE

(71) Applicant: ZEON CORPORATION, Chiyoda-ku, Tokyo (JP)

(72) Inventor: Manabu TSUBURAYA, Tokyo (JP)

(73) Assignee: ZEON CORPORATION, Chiyoda-ku, Tokyo (JP)

(21) Appl. No.: 15/555,616

(22) PCT Filed: Feb. 10, 2016
(86) PCT No.: PCT/JP2016/053938

§ 371 Date: Sep. 5, 2017

(30) Foreign Application Priority Data
Mar. 16, 2015 (JP) 2015-052477

(51) Int. Cl. B32B 27/08; G02F 1/1335; G02B 5/30; B29D 11/00; B32B 27/32

(52) U.S. Cl. CPC B32B 27/08; B29D 11/00644; B32B 27/32; G02B 5/305; G02F 1/133528; B29C 47/065

(57) ABSTRACT

An optical layered body including a substrate layer and a first surface layer, wherein the substrate layer includes a polymer containing an amorphous alicyclic structure, and the first surface layer includes a polymer containing a crystallizable alicyclic structure; a polarizing plate including such an optical layered body and a polarizer; and a liquid crystal display device including such a polarizing plate. Preferably, the optical layered body has a specific retardation, the first surface layer has a specific thickness, and the polymer containing a crystallizable alicyclic structure is a hydrogenated product of a ring-opened polymer of dicyclopentadiene.

### FIELD

The present invention relates to an optical layered body, as well as a polarizing plate and a liquid crystal display device each including the optical layered body.

### BACKGROUND

When a liquid crystal display device is viewed through polarized sunglasses, sometimes the brightness of an image may extremely decrease, and the image may become visually unrecognizable. To address this concern, Patent Literature 1 proposes to bond a ¼ wave plate to a viewing side of a polarizer of a liquid crystal display device for improving the brightness of an image when viewed through polarized sunglasses.

On a polarizer to be provided to a liquid crystal display device, a film for protecting a polarizing plate is sometimes provided for protection of the polarizer. The applicant has proposed a film for protecting a polarizing plate which includes a polymer containing an alicyclic structure, taking advantage of excellent characteristics possessed by the polymer containing an alicyclic structure (see Patent Literature 2).

Furthermore, it is known that a hydrogenated product of a ring-opened polymer of dicyclopentadiene having crystallizability, among the polymers containing an alicyclic structure, is excellent in chemical resistance (see Patent Literature 3).

### CITATION LIST

### Patent Literature

Patent Literature 1: Japanese Patent No. 4689769 B (corresponding publication: U.S. Patent Application Publication No. 2011/199561)

Patent Literature 2: Japanese Patent No. 4461795 B

Patent Literature 3: Japanese Patent Application Laid-Open No. 2013-010309 A

### SUMMARY

### Technical Problem

In consideration of the technologies disclosed in Patent Literatures 1 to 3, the inventor attempted to develop a film for protecting a polarizing plate which is excellent in chemical resistance, using a hydrogenated product of a ring-opened polymer of dicyclopentadiene having crystallizability. However, it was found that when a polarizing plate including the aforementioned film for protecting a polarizing plate is provided to a liquid crystal display device, an image viewed through polarized sunglasses had a deteriorated display quality such as rainbow-like color unevenness or darkness.

Furthermore, the film for protecting a polarizing plate can be bent in use depending on its application. For this reason, the film for protecting a polarizing plate is required to have an excellent bending resistance.

The present invention has been devised in view of the aforementioned problems. An object of the present invention is to provide: an optical layered body which allows a liquid crystal display device to have a favorable display quality when viewed through polarized sunglasses and which is excellent in chemical resistance and bending resistance; a polarizing plate including the optical layered body which allows a liquid crystal display to have a favorable display quality when viewed through polarized sunglasses and which is excellent in chemical resistance and bending resistance; and a liquid crystal display device including the optical layered body which allows a liquid crystal display to have a favorable display quality when viewed through polarized sunglasses and which is excellent in chemical resistance and bending resistance.

### Solution to Problem

The present inventor intensively conducted research for solving the aforementioned problem. As a result, the present inventor has found that an optical layered body which includes a combination of a substrate layer containing a polymer having an amorphous alicyclic structure and a first surface layer containing a polymer containing a crystallizable alicyclic structure allows a liquid crystal display device to have a favorable display quality when viewed through polarized sunglasses, and is excellent in chemical resistance and bending resistance. Thus, the present invention has been completed.

That is, the present invention is as follows.

(1) An optical layered body comprising a substrate layer and a first surface layer, wherein

the substrate layer includes a polymer containing an amorphous alicyclic structure, and

the first surface layer includes a polymer containing a crystallizable alicyclic structure.

(2) The optical layered body according to (1), wherein

the optical layered body has a retardation of 400 nm or less, and

the first surface layer has a thickness of 0.1 μm to 5.0 μm.

(3) The optical layered body according to (1) or (2), wherein the polymer containing a crystallizable alicyclic structure is a hydrogenated product of a ring-opened polymer of dicyclopentadiene.
(4) The optical layered body according to any one of (1) to (3), wherein the optical layered body has a transmittance at a wavelength of 380 nm of 10% or less.
(5) The optical layered body according to any one of (1) to (4), further comprising a second surface layer on the substrate layer opposite the first surface layer, wherein

the second surface layer includes a polymer containing a crystallizable alicyclic structure.

(6) The optical layered body according to any one of (1) to (5), wherein

the optical layered body has a long-length shape, and

a slow axis of the optical layered body is neither parallel to nor perpendicular to a longitudinal direction of the optical layered body.

(7) The optical layered body according to (6), wherein an orientation angle relative to the longitudinal direction of the optical layered body is 45°±5°.
(8) A polarizing plate comprising the optical layered body according to any one of (1) to (7) and a polarizer.
(9) A liquid crystal display device comprising the polarizing plate according to (8).

### Advantageous Effects of Invention

According to the present invention, there can be provided: an optical layered body which allows a liquid crystal display device to has a favorable display quality when viewed through polarized sunglasses and which is excellent in chemical resistance and bending resistance; a polarizing plate including the optical layered body which allows a liquid crystal display to have a favorable display quality when viewed through polarized sunglasses and which is excellent in chemical resistance and bending resistance; and a liquid crystal display device including the optical layered body which allows a liquid crystal display to have a favorable display quality when viewed through polarized sunglasses and which is excellent in chemical resistance and bending resistance.

### DESCRIPTION OF EMBODIMENTS

Hereinafter, the present invention will be described in detail with reference to embodiments and examples. However, the present invention is not limited to the following embodiments and examples, and may be freely modified for implementation without departing from the scope of claims of the present invention and the scope of their equivalents.

In the following description, a retardation refers to an in-plane retardation, unless otherwise stated. An in-plane retardation Re of a film is a value represented by Re=(nx−ny)×d, unless otherwise stated. Herein nx represents a refractive index in a direction that is perpendicular to the thickness direction (in-plane direction) of the film and provides a maximum refractive index. ny represents a refractive index in a direction that is in an in-plane direction of the film and is perpendicular to the direction of nx. d represents the thickness of the film. The measurement wavelength is 550 nm, unless otherwise stated.

In the following description, a slow axis of a film refers to an in-plane slow axis of the film, unless otherwise stated.

In the following description, the “¼ wave plate” and “polarizing plate” are each used as a term which encompasses not only a rigid member but also a flexible member such as a resin film, unless otherwise stated.

In the following description, the film “having a long-length shape” refers to a film having usually a length that is 5 or more times its width, preferably a length that is 10 or more times its width, and specifically a length to a degree that allows the film to be wound up into a roll shape to be stored or transported.

In the following description, when the direction of an element is “parallel” and “perpendicular”, it may contain an error within the range that does not impair the effects of the present invention, for example, within the range of ±5°, preferably ±3°, and more preferably ±1°, unless otherwise stated.

[1. Optical Layered Body]

[1.1. Outline of Optical Layered Body]

The optical layered body according to the present invention is a film with a multi-layer structure which includes a substrate layer and a first surface layer. The optical layered body according to the present invention preferably further includes a second surface layer on the substrate layer opposite the first surface layer. Therefore, the optical layered body according to the present invention preferably includes the first surface layer, the substrate layer, and the second surface layer in this order.

[1.2. Substrate Layer]

The substrate layer includes a polymer containing an amorphous alicyclic structure. Therefore, the substrate layer is usually a resin layer which is formed of a resin which includes the polymer containing an amorphous alicyclic structure. Hereinafter, the polymer containing an amorphous alicyclic structure may be appropriately referred to as an “amorphous alicyclic structure polymer”. The resin which includes the amorphous alicyclic structure polymer may be appropriately referred to as an “amorphous resin”. The amorphous resin is usually a thermoplastic resin. The amorphous alicyclic structure polymer used in the present invention is an amorphous polymer which does not have a melting point [that is, its melting point cannot be recognized with a differential scanning calorimeter (DSC)].

The amorphous alicyclic structure polymer is an amorphous polymer of which a structural unit contains an alicyclic structure. The amorphous alicyclic structure polymer usually has excellent resistance against moisture and heat. Therefore, the use of the amorphous alicyclic structure polymer improves resistance of the optical layered body against moisture and heat.

The amorphous alicyclic structure polymer may have an alicyclic structure in its main chain, or may have an alicyclic structure in its side chain. Among these, a polymer containing an alicyclic structure in its main chain is preferable, from the viewpoint of mechanical strength and heat resistance.

Examples of the alicyclic structure may include a saturated alicyclic hydrocarbon (cycloalkane) structure, and an unsaturated alicyclic hydrocarbon (cycloalkene, cycloalkyne) structure. Among these, from the viewpoint of mechanical strength and heat resistance, a cycloalkane structure and a cycloalkene structure are preferable, and a cycloalkane structure is particularly preferable.

The number of carbon atoms which constitute the alicyclic structure is, per one alicyclic structure, preferably 4 or more, and more preferably 5 or more, and is preferably 30 or less, more preferably 20 or less, and particularly preferably 15 or less. When the number of carbon atoms which constitute the alicyclic structure falls within this range, mechanical strength, heat resistance, and molding properties of the amorphous resin can be highly balanced.

In the amorphous alicyclic structure polymer, the ratio of a structural unit having an alicyclic structure may be appropriately selected depending on its intended use. The ratio of the structural unit having an alicyclic structure in the amorphous alicyclic structure polymer is preferably 55% by weight or more, further preferably 70% by weight or more, and particularly preferably 90% by weight or more. When the ratio of the structural unit having an alicyclic structure in the amorphous alicyclic structure polymer falls within this range, the amorphous resin containing the amorphous alicyclic structure polymer can have favorable transparency and heat resistance.

Examples of the amorphous alicyclic structure polymer may include a norbornene-based polymer, a monocyclic olefin-based polymer, a cyclic conjugated diene-based polymer, a vinyl alicyclic hydrocarbon polymer, and a hydrogenated product thereof. Among these, since favorable transparency and molding properties can be obtained, a norbornene-based polymer is more preferable.

Examples of the norbornene-based polymer may include: a ring-opened polymer of a monomer having a norbornene structure and a hydrogenated product thereof; and an addition polymer of a monomer having a norbornene structure and a hydrogenated product thereof. Examples of the ring-opened polymer of a monomer having a norbornene structure may include a ring-opened homopolymer of one type of monomer having a norbornene structure, a ring-opened copolymer of two or more types of monomers each having a norbornene structure, and a ring-opened copolymer of a monomer having a norbornene structure and an optional monomer which is copolymerizable with the monomer having a norbornene structure. Furthermore, examples of the addition polymer of a monomer having a norbornene structure may include an addition homopolymer of one type of monomer having a norbornene structure, an addition copolymer of two or more types of monomers each having a norbornene structure, and an addition copolymer of a monomer having a norbornene structure and an optional monomer which is copolymerizable with the monomer having a norbornene structure. Among these, a hydrogenated product of a ring-opened polymer of a monomer having a norbornene structure is particularly suitable from the viewpoint of molding properties, heat resistance, low hygroscopicity, size stability, lightweight properties, and the like.

Examples of the monomer having a norbornene structure may include bicyclo[2.2.1]hept-2-ene (common name: norbornene), tricyclo[4.3.0.1^{2,5}]dec-3,7-diene (common name: dicyclopentadiene), 7,8-benzotricyclo[4.3.0.1^{2,5}]dec-3-ene (common name: methanotetrahydrofluorene), tetracyclo[4.4.0.1^{2,5}.1^{7,10}]dodeca-3-ene (common name: tetracyclododecene), and derivatives of these compounds (for example, a derivative having a substituent on the ring). Here, examples of the substituent may include an alkyl group, an alkylene group, and a polar group. A plurality of the substituents, which are the same as or different from each other, may be bonded on the ring. As the monomer having a norbornene structure, one type thereof may be solely used, and two or more types thereof may also be used in combination at any ratio.

Examples of the polar group may include a hetero atom, or an atomic group having a hetero atom. Examples of the hetero atom may include an oxygen atom, a nitrogen atom, a sulfur atom, a silicon atom, and a halogen atom. Specific examples of the polar group may include a carboxyl group, a carbonyloxycarbonyl group, an epoxy group, a hydroxyl group, an oxy group, an ester group, a silanol group, a silyl group, an amino group, a nitrile group, and a sulfonic acid group.

Examples of the monomer which is ring-opening copolymerizable with the monomer having a norbornene structure may include: monocyclic olefins such as cyclohexene, cycloheptene and cyclooctene, and derivatives thereof; and cyclic conjugated diene such as cyclohexadiene and cycloheptadiene, and a derivative thereof. As the monomer which is ring-opening copolymerizable with the monomer having a norbornene structure, one type thereof may be solely used, and two or more types thereof may also be used in combination at any ratio.

The ring-opened polymer of a monomer having a norbornene structure may be produced by, for example, the polymerization or copolymerization of a monomer in the presence of a ring-opening polymerization catalyst.

Examples of the monomer which is addition copolymerizable with the monomer having a norbornene structure may include: α-olefin having 2 to 20 carbon atoms such as ethylene, propylene, and 1-butene, and derivatives thereof; cycloolefin such as cyclobutene, cyclopentene and cyclohexene, and derivatives thereof; and non-conjugated diene such as 1,4-hexadiene, 4-methyl-1,4-hexadiene, and 5-methyl-1,4-hexadiene. Among these, α-olefin is preferable, and ethylene is more preferable. As the monomer which is addition copolymerizable with the monomer having a norbornene structure, one type thereof may be solely used, and two or more types thereof may also be used in combination at any ratio.

The addition polymer of a monomer having a norbornene structure may be produced by, for example, the polymerization or copolymerization of a monomer in the presence of an addition polymerization catalyst.

The hydrogenated product of the ring-opened polymer or the addition polymer described above may be produced by, for example, hydrogenating preferably 90% or more of unsaturated carbon-carbon bonds in a solution of the ring-opened polymer or the addition polymer, in the presence of a hydrogenation catalyst which contains transition metal such as nickel and palladium.

It is preferable that the norbornene-based polymer includes, as a structural unit, X: a bicyclo[3.3.0]octane-2,4-diyl-ethylene structure, and Y: a tricyclo[4.3.0.1^{2,5}]decane-7,9-diyl-ethylene structure, and the norbornene-based polymer contains these structural units in an amount of 90% by weight or more relative to the entire structural units of the norbornene-based polymer, wherein ratio between the proportion of X and the proportion of Y is 100:0 to 40:60 in terms of the weight ratio of X:Y. The use of such a polymer enables the substrate layer which contains the norbornene-based polymer to show no changes in size in a long period of time and be excellent in stability of optical characteristics.

The weight-average molecular weight (Mw) of the amorphous alicyclic structure polymer is preferably 10,000 or more, more preferably 15,000 or more, and particularly preferably 20,000 or more, and is preferably 100,000 or less, more preferably 80,000 or less, and particularly preferably 50,000 or less. When the weight-average molecular weight falls within such a range, mechanical strength and molding processability of the substrate layer which contains the amorphous alicyclic structure polymer can be highly balanced.

The molecular weight distribution (weight-average molecular weight (Mw)/number-average molecular weight (Mn)) of the amorphous alicyclic structure polymer is preferably 1.2 or more, more preferably 1.5 or more, and particularly preferably 1.8 or more, and is preferably 3.5 or less, more preferably 3.0 or less, and particularly preferably 2.7 or less. When the molecular weight distribution is equal to or more than the lower limit value of the aforementioned range, the productivity of a polymer can be enhanced, thereby reducing production costs. When the molecular weight distribution is equal to or less than the upper limit value, the amount of a low-molecular component is reduced. This can suppress relaxation during exposure to high temperature to enhance the stability of the substrate layer which contains the amorphous alicyclic structure polymer.

The weight-average molecular weight (Mw) and the number-average molecular weight (Mn) may be measured as a weight-average molecular weight in terms of polyisoprene or polystyrene by gel permeation chromatography with cyclohexane as a solvent (however, when a sample is not dissolved in cyclohexane, toluene may be used).

The glass transition temperature of the amorphous alicyclic structure polymer is preferably 100° C. or higher, more preferably 110° C. or higher, and particularly preferably 120° C. or higher, and is preferably 160° C. or lower, more preferably 150° C. or lower, and particularly preferably 140° C. or lower. When the glass transition temperature of the amorphous alicyclic structure polymer is equal to or higher than the lower limit value of the aforementioned range, the optical layered body can have enhanced durability under a high temperature environment. When the glass transition temperature is equal to or lower than the upper limit value of the aforementioned range, the optical layered body can be easily subjected to a stretching treatment.

The saturated water absorption ratio of the amorphous alicyclic structure polymer is preferably 0.03% by weight or less, further preferably 0.02% by weight or less, and particularly preferably 0.01% by weight or less. When the saturated water absorption ratio falls within the aforementioned range, the substrate layer which contains the amorphous alicyclic structure polymer can have reduced time-dependent changes in optical characteristics such as a retardation. Further, deterioration of a polarizing plate and a liquid crystal display device each including the optical layered body can be suppressed, and a display of a liquid crystal display device can be maintained to be stable and favorable in a long period of time.

The saturated water absorption ratio is a value represented by a percentage of the mass which increased after a sample was immersed in water at a certain temperature for a certain period of time relative to the mass of a test piece before the immersion. Usually, the measurement is performed by an immersion of a sample in water at 23° C. for 24 hours. The saturated water absorption ratio of a polymer may be adjusted within the aforementioned range by, for example, decreasing the amount of a polar group in the polymer. Therefore, from the viewpoint of reducing the saturated water absorption ratio, it is preferable that the amorphous alicyclic structure polymer does not have a polar group.

The amount of the amorphous alicyclic structure polymer in the amorphous resin is preferably 80.0% by weight or more, more preferably 85.0% by weight or more, and particularly preferably 90.0% by weight or more, and is preferably 99.0% by weight or less, more preferably 97.0% by weight or less, and particularly preferably 95.0% by weight or less. When the amount of the amorphous alicyclic structure polymer falls within the aforementioned range, the polarizing plate including the optical layered body can have enhanced durability under humidified conditions.

The substrate layer preferably contains an ultraviolet ray absorber. Accordingly, the amorphous resin which forms the substrate layer preferably contains an ultraviolet ray absorber. The use of an ultraviolet ray absorber can inhibit an organic component contained in the polarizing plate including the optical layered body from deteriorating due to ultraviolet rays, thereby improving the durability of the polarizing plate. Furthermore, a liquid crystal panel of a liquid crystal display device can be inhibited from deteriorating due to ultraviolet rays. For example, the optical layered body can inhibit a liquid crystal panel from deteriorating due to ultraviolet rays contained in outside light. Further, for example, the method for producing a liquid crystal display device may include a step of bonding an optional member with an ultraviolet curable adhesive. At this time, the optical layered body can inhibit the liquid crystal panel from deteriorating due to ultraviolet rays which is used for curing the adhesive.

As the ultraviolet ray absorber, a compound which is capable of absorbing ultraviolet rays may be used. Examples of the ultraviolet ray absorber may include organic ultraviolet ray absorbers, such as a triazine-based ultraviolet ray absorber, a benzophenone-based ultraviolet ray absorber, a benzotriazole-based ultraviolet ray absorber, and an acrylonitrile-based ultraviolet ray absorber.

Preferable examples of the triazine-based ultraviolet ray absorber may include a compound having a 1,3,5-triazine ring. Specific examples of the triazine-based ultraviolet ray absorber may include 2-(4,6-diphenyl-1,3,5-triazine-2-yl)-5-[(hexyl)oxy]-phenol, and 2,4-bis(2-hydroxy-4-butoxyphenyl)-6-(2,4-dibutoxyphenyl)-1,3,5-triazine.

Examples of the benzotriazole-based ultraviolet ray absorber may include 2,2′-methylenebis[4-(1,1,3,3-tetramethylbutyl)-6-(2H-benzotriazole-2-yl)phenol], 2-(3,5-di-tert-butyl-2-hydroxyphenyl)-5-chlorobenzotriazole, 2-(2H-benzotriazole-2-yl)-p-cresol, 2-(2H-benzotriazole-2-yl)-4,6-bis(1-methyl-1-phenylethyl)phenol, 2-benzotriazole-2-yl-4,6-di-tert-butylphenol, 2-[5-chloro(2H)-benzotriazole-2-yl]-4-methyl-6-(tert-butyl)phenol, 2-(2H-benzotriazole-2-yl)-4,6-di-tert-butylphenol, 2-(2H-benzotriazole-2-yl)-4-(1,1,3,3-tetramethylbutyl)phenol, 2-(2H-benzotriazole-2-yl)-4-methyl-6-(3,4,5,6-tetrahydrophthalimidylmethyl)phenol, a reaction product of methyl 3-(3-(2H-benzotriazole-2-yl)-5-tert-butyl-4-hydroxyphenyl)propionate/polyethylene glycol 300, and 2-(2H-benzotriazole-2-yl)-6-(linear and branched dodecyl)-4-methylphenol.

As the ultraviolet ray absorber, one type thereof may be solely used, and two or more types thereof may also be used in combination at any ratio.

The amount of the ultraviolet ray absorber in the amorphous resin is preferably 1.0% by weight or more, more preferably 3.0% by weight or more, and particularly preferably 5.0% by weight or more, and is preferably 20.0% by weight or less, more preferably 15.0% by weight or less, and particularly preferably 10.0% by weight or less. When the amount of the ultraviolet ray absorber is equal to or more than the lower limit value of the aforementioned range, durability to light, such as ultraviolet rays, of the polarizing plate including the optical layered body can be effectively enhanced. When the amount is equal to or less than the upper limit value of the aforementioned range, the transmittance of the polarizing plate including the optical layered body can be enhanced. For achieving the optical layered body having an adequate range of transmittance at a wavelength of 380 nm, the amount of the ultraviolet ray absorber may be appropriately adjusted depending on the thickness of the substrate layer.

Any method may be adopted as the method for producing the amorphous resin which contains the ultraviolet ray absorber. Examples thereof may include a method of adding the ultraviolet ray absorber to the amorphous alicyclic structure polymer prior to the production of a layered body by a melt extrusion method; a method of using a masterbatch which contains the ultraviolet ray absorber in a high concentration; and a method of adding the ultraviolet ray absorber to the amorphous alicyclic structure polymer during the production of a layered body by a melt extrusion method.

The amorphous resin may further contain an optional component, in addition to the amorphous alicyclic structure polymer and the ultraviolet ray absorber. Examples of the optional component may include compounding agents such as: a coloring agent such as a pigment and a dye; a plasticizer; a fluorescent brightener; a dispersant; a thermal stabilizer; a light stabilizer; an antistatic agent; an antioxidant; and a surfactant. As the optional component, one type thereof may be solely used, and two or more types thereof may also be used in combination at any ratio.

The thickness of the substrate layer is preferably 1.0 μm or more, more preferably 5.0 μm or more, and particularly preferably 7.0 μm or more, and is preferably 45 μm or less, more preferably 35 μm or less, and particularly preferably 30 μm or less. When the thickness of the substrate layer is equal to or more than the lower limit value of the aforementioned range, the ratio of the ultraviolet ray absorber relative to the substrate layer can be set at a low level. When the thickness is equal to or less than the upper limit value of the aforementioned range, the optical layered body can have increased mechanical properties.

Here, the thickness of each layer contained in the optical layered body, such as the substrate layer and the surface layer (the first surface layer and the second surface layer), may be measured by the following method.

The optical layered body is embedded in an epoxy resin to prepare a sample piece. This sample piece is sliced into a thickness of 0.05 μm using a microtome. Thereafter, the cross section which has appeared by the slicing is observed with a microscope. Accordingly, the thickness of each layer contained in the optical layered body can be measured.

When the optical layered body has a long-length shape, and the substrate layer has a slow axis, the slow axis of the substrate layer is preferably in a diagonal direction which is neither parallel to nor perpendicular to the longitudinal direction of the optical layered body. In particular, the orientation angle θ of the substrate layer relative to the longitudinal direction of the optical layered body is preferably 45°±5°. Here, the aforementioned orientation angle θ represents an angle formed by the slow axis relative to the longitudinal direction of the optical layered body. More particularly, the aforementioned orientation angle θ of the substrate layer is preferably 40° or more, more preferably 43° or more, and particularly preferably 44° or more, and is preferably 50° or less, more preferably 47° or less, and particularly preferably 46° or less. By having such an angle, the angle between the slow axis of an optical layered body and the polarized light transmission axis of a polarizer can be easily adjusted when bonding the optical layered body and the polarizer to produce a polarizing plate.

[1.3. First Surface Layer]

The first surface layer includes a polymer containing a crystallizable alicyclic structure. Therefore, the first surface layer is usually a resin layer which is formed of a resin which includes the polymer containing a crystallizable alicyclic structure. Hereinafter, the polymer containing a crystallizable alicyclic structure may be appropriately referred to as a “crystallizable alicyclic structure polymer”. The resin which includes the crystallizable alicyclic structure polymer may be appropriately referred to as a “crystallizable resin”. The crystallizable resin is usually a thermoplastic resin.

The crystallizable alicyclic structure polymer is a crystallizable polymer which has an alicyclic structure in its molecule. Examples thereof may include a polymer which may be obtained by the polymerization reaction with cyclic olefin as a monomer, and a hydrogenated product thereof. The crystallizable alicyclic structure polymer is excellent in chemical resistance and mechanical strength, and furthermore, usually excellent in heat resistance.

As the crystallizable alicyclic structure polymer, one type thereof may be solely used, and two or more types thereof may also be used in combination at any ratio.

Examples of the alicyclic structure possessed by the crystallizable alicyclic structure polymer may include a cycloalkane structure and a cycloalkene structure. Among these, a cycloalkane structure is preferable, because the optical layered body having excellent characteristics such as thermal stability is easily obtainable. The number of carbon atoms contained in one alicyclic structure is preferably 4 or more, and more preferably 5 or more, and is preferably 30 or less, more preferably 20 or less, and particularly preferably 15 or less. When the number of carbon atoms contained in one alicyclic structure falls within the aforementioned range, mechanical strength, heat resistance, and molding properties are highly balanced.

The ratio of the structural unit having an alicyclic structure relative to all structural units in the crystallizable alicyclic structure polymer is preferably 30% by weight or more, more preferably 50% by weight or more, and particularly preferably 70% by weight or more. When the ratio of the structural unit having an alicyclic structure in the crystallizable alicyclic structure polymer is set to be high as previously described, heat resistance can be enhanced.

The remainder other than the structural unit having an alicyclic structure in the crystallizable alicyclic structure polymer is not particularly limited, and may be appropriately selected depending on its intended use.

The crystallizable alicyclic structure polymer is a polymer having crystallizability. As described herein, the “polymer having crystallizability” refers to a polymer which has a melting point [that is, of which a melting point can be observed using a differential scanning calorimeter (DSC)]. The melting point of the crystallizable alicyclic structure polymer is preferably 200° C. or higher, and more preferably 230° C. or higher, and is preferably 290° C. or lower. The use of the crystallizable alicyclic structure polymer having such a melting point can provide the optical layered body having a further excellent balance of molding properties and heat resistance.

The weight-average molecular weight (Mw) of the crystallizable alicyclic structure polymer is preferably 1,000 or more, and more preferably 2,000 or more, and is preferably 1,000,000 or less, and more preferably 500,000 or less. The crystallizable alicyclic structure polymer having such a weight-average molecular weight has an excellent balance of molding processability and heat resistance.

The molecular weight distribution (Mw/Mn) of the crystallizable alicyclic structure polymer is preferably 1.0 or more, and more preferably 1.5 or more, and is preferably 4.0 or less, and more preferably 3.5 or less. The crystallizable alicyclic structure polymer having such a molecular weight distribution is excellent in molding processability.

The weight-average molecular weight (Mw) and molecular weight distribution (Mw/Mn) of the crystallizable alicyclic structure polymer may be measured in terms of polystyrene by gel permeation chromatography (GPC) with tetrahydrofuran as a development solvent.

The glass transition temperature Tg of the crystallizable alicyclic structure polymer is usually, but not particularly limited to, in the range of 85° C. or higher and 170° C. or lower.

Examples of the crystallizable alicyclic structure polymer may include the following polymers (α) to (δ). Among these, the polymer (β) is preferable as the crystallizable alicyclic structure polymer, because the optical layered body having excellent heat resistance is easily obtainable.

Polymer (α): a ring-opened polymer of a cyclic olefin monomer, which has crystallizability.

Polymer (β): a hydrogenated product of the polymer (α), which has crystallizability.

Polymer (γ): an addition polymer of a cyclic olefin monomer, which has crystallizability.

Polymer (δ): a hydrogenated product of the polymer (γ) or the like, which has crystallizability.

Specifically, the crystallizable alicyclic structure polymer is more preferably a ring-opened polymer of dicyclopentadiene which has crystallizability, and a hydrogenated product of the ring-opened polymer of dicyclopentadiene which has crystallizability, and particularly preferably a hydrogenated product of the ring-opened polymer of dicyclopentadiene which has crystallizability. As described herein, the ring-opened polymer of dicyclopentadiene refers to a polymer in which the ratio of the dicyclopentadiene-derived structural unit relative to all structural units is usually 50% by weight or more, preferably 70% by weight or more, more preferably 90% by weight or more, and further preferably 100% by weight.

Hereinafter, the method for producing the polymer (α) and the polymer (β) will be described.

The cyclic olefin monomer which may be used for producing the polymer (α) and the polymer (β) is a compound which has a cyclic structure formed with carbon atoms and includes a carbon-carbon double bond in the ring. Examples of the cyclic olefin monomer may include a norbornene-based monomer. When the polymer (α) is a copolymer, monocyclic olefin may be used as the cyclic olefin monomer.

The norbornene-based monomer is a monomer which contains a norbornene ring. Examples of the norbornene-based monomer may include a bicyclic monomer, such as bicyclo[2.2.1]hept-2-ene (common name: norbornene), and 5-ethylidene-bicyclo[2.2.1]hept-2-ene (common name: ethylidene norbornene) and a derivative thereof (for example, a monomer which has a substituent in a ring); a tricyclic monomer, such as tricyclo[4.3.0.1^{2,5}]dec-3,7-diene (common name: dicyclopentadiene) and a derivative thereof; and a tetracyclic monomer, such as 7,8-benzotricyclo[4.3.0.1^{2,5}]dec-3-ene (common name: methanotetrahydrofluorene: also referred to as 1,4-methano-1,4,4a,9a-tetrahydrofluorene) and a derivative thereof, tetracyclo[4.4.0.1^{2,5}.1^{7,10}]dodeca-3-ene (common name: tetracyclododecene), and 8-ethylidenetetracyclo[4.4.0.1^{2,5}.1^{7,10}]-3-dodecene and a derivative thereof.

Examples of the substituent in the aforementioned monomer may include: an alkyl group, such as a methyl group and an ethyl group; an alkyenyl group, such as a vinyl group; an alkylidene group, such as propane-2-ylidene; an aryl group, such as a phenyl group; a hydroxy group; an acid anhydride group; a carboxyl group; and an alkoxycarbonyl group, such as a methoxycarbonyl group. As the aforementioned substituent, one type thereof may be solely used, and two or more types thereof may also be used in combination at any ratio.

Examples of the monocyclic olefin may include cyclic monoolefins, such as cyclobutene, cyclopentene, methylcyclopentene, cyclohexene, methylcyclohexene, cycloheptene, and cyclooctene; and cyclic diolefins, such as cyclohexadiene, methylcyclohexadiene, cyclooctadiene, methylcyclooctadiene, and phenylcyclooctadiene.

As the cyclic olefin monomer, one type thereof may be solely used, and two or more types thereof may also be used in combination at any ratio. When two or more types of cyclic olefin monomers are used, the polymer (α) may be a block copolymer or a random copolymer.

The cyclic olefin monomer may include an endo-form stereoisomer and/or an exo-form stereoisomer. As the cyclic olefin monomer, any one of an endo form and an exo form may be used. One of an endo form and an exo form may be used alone. Alternatively, an isomer mixture which contains an end form and an exo form at any ratio may also be used. Among these, it is preferable that one of the stereoisomers has a higher ratio, because the crystallizability of the crystallizable alicyclic structure polymer is enhanced so that the optical layered body having more excellent heat resistance is easily obtainable. For example, the ratio of an endo form or an exo form is preferably 80% or more, more preferably 90% or more, and further preferably 95% or more. It is preferable that the endo form has a higher ratio because synthesis thereof can be easily performed.

The crystallizability of the polymer (α) and the polymer (β) can be usually increased by increasing the degree of its syndiotactic stereoregularity (the ratio of a racemo diad). From the viewpoint of increasing the level of the stereoregularity of the polymer (α) and the polymer (β), the ratio of a racemo diad in structural units of the polymer (α) and the polymer (β) is preferably 51% or more, more preferably 60% or more, and particularly preferably 70% or more.

The ratio of the racemo diad may be measured by ¹³C-NMR spectrum analysis. Specifically, the ratio may be measured by the following method.

The ¹³C-NMR measurement of a polymer sample is performed by an inverse-gated decoupling method at 200° C., with ortho-dichlorobenzene-d⁴ as a solvent. From the result of this ¹³C-NMR measurement, the ratio of a racemo diad in the polymer sample may be calculated on the basis of the ratio in strength between the signal at 43.35 ppm derived from a meso diad and the signal at 43.43 ppm derived from a racemo diad, with the peak at 127.5 ppm of ortho-dichlorobenzene-d⁴ as a reference shift.

For synthesizing the polymer (α), a ring-opening polymerization catalyst is usually used. As the ring-opening polymerization catalyst, one type thereof may be solely used, and two or more types thereof may also be used in combination at any ratio. Such a ring-opening polymerization catalyst for synthesizing the polymer (α) is preferably capable of causing the cyclic olefin monomer to be ring-opening polymerized to generate a ring-opened polymer having syndiotactic stereoregularity. Examples of the preferable ring-opening polymerization catalyst may include a ring-opening polymerization catalyst which contains a metal compound represented by the following formula (1).

M(NR¹)X₄₋ₐ(OR²)ₐ.L_{b} (1)

(in the formula (1),

M is a metal atom selected from the group consisting of transition metal atoms of group 6 in the periodic table,

R¹ is a phenyl group optionally having a substituent at one or more of the 3-position, 4-position and 5-position, or a group represented by —CH₂R³ (R³ is a group selected from the group consisting of a hydrogen atom, an alkyl group optionally having a substituent, and an aryl group optionally having a substituent),

R² is a group selected from the group consisting of an alkyl group optionally having a substituent and an aryl group optionally having a substituent,

X is a group selected from the group consisting of a halogen atom, an alkyl group optionally having a substituent, an aryl group optionally having a substituent, and an alkylsilyl group,

L is an electron-donating neutral ligand,

a is a number of 0 or 1, and

b is an integer of 0 to 2).

In the formula (1), M is a metal atom selected from the group consisting of transition metal atoms of group 6 in the periodic table. This M is preferably chromium, molybdenum or tungsten, more preferably molybdenum or tungsten, and particularly preferably tungsten.

In the formula (1), R¹ is a phenyl group optionally having a substituent at one or more of the 3-position, 4-position and 5-position, or a group represented by —CH₂R³.

The number of carbon atoms of the phenyl group optionally having a substituent at one or more of the 3-position, 4-position and 5-position of R¹ is preferably 6 to 20, and more preferably 6 to 15. Examples of the substituent may include: an alkyl group, such as a methyl group and an ethyl group; a halogen atom, such as a fluorine atom, a chlorine atom, and a bromine atom; and an alkoxy group, such as a methoxy group, an ethoxy group, and an isopropoxy group. As these substituents, one type thereof may be solely used, and two or more types thereof may also be used in combination at any ratio. Furthermore, in R¹, the substituents present at two or more of the 3-position, 4-position and 5-position may be bonded to each other to form a cyclic structure.

Examples of the phenyl group optionally having a substituent at one or more of the 3-position, 4-position and 5-position may include: an unsubstituted phenyl group; a monosubstituted phenyl group, such as a 4-methylphenyl group, a 4-chlorophenyl group, a 3-methoxyphenyl group, a 4-cyclohexylphenyl group, and a 4-methoxyphenyl group; a disubstituted phenyl group, such as a 3,5-dimethylphenyl group, a 3,5-dichlorophenyl group, a 3,4-dimethylphenyl group, and a 3,5-dimethoxyphenyl group; a trisubstituted phenyl group, such as a 3,4,5-trimethylphenyl group, and a 3,4,5-trichlorophenyl group; and a 2-naphtyl group optionally having a substituent, such as a 2-naphtyl group, a 3-methyl-2-naphtyl group, and a 4-methyl-2-naphtyl group.

In the group represented by —CH₂R³ of R¹, R³ is a group selected from the group consisting of a hydrogen atom, an alkyl group optionally having a substituent, and an aryl group optionally having a substituent.

The number of carbon atoms of the alkyl group optionally having a substituent of R³ is preferably 1 to 20, and more preferably 1 to 10. This alkyl group may be linear or branched. Furthermore, examples of the substituent may include: a phenyl group optionally having a substituent, such as a phenyl group and a 4-methylphenyl group; and an alkoxyl group, such as a methoxy group and an ethoxy group. As these substituents, one type thereof may be solely used, and two or more types thereof may also be used in combination at any ratio.

Examples of the alkyl group optionally having a substituent of R³ may include a methyl group, an ethyl group, a propyl group, an isopropyl group, a butyl group, an isobutyl group, a t-butyl group, a pentyl group, a neopentyl group, a benzyl group, and a neophyl group.

The number of carbon atoms of the aryl group optionally having a substituent of R³ is preferably 6 to 20, and more preferably 6 to 15. Furthermore, examples of the substituent may include: an alkyl group, such as a methyl group and an ethyl group; a halogen atom, such as a fluorine atom, a chlorine atom, and a bromine atom; and an alkoxy group, such as a methoxy group, an ethoxy group, and an isopropoxy group. As these substituents, one type thereof may be solely used, and two or more types thereof may also be used in combination at any ratio.

Examples of the aryl group optionally having a substituent of R³ may include a phenyl group, a 1-naphtyl group, a 2-naphtyl group, a 4-methylphenyl group, and a 2,6-dimethylphenyl group.

Among these, as the group represented by R³, an alkyl group having 1 to 20 carbon atoms is preferable.

In the formula (1), R² is a group selected from the group consisting of an alkyl group optionally having a substituent and an aryl group optionally having a substituent. The alkyl group optionally having a substituent and the aryl group optionally having a substituent of R² may be optionally selected from the ranges enumerated as the alkyl group optionally having a substituent and the aryl group optionally having a substituent of R³, respectively.

In the formula (1), X is a group selected from the group consisting of a halogen atom, an alkyl group optionally having a substituent, an aryl group optionally having a substituent, and an alkylsilyl group.

Examples of the halogen atom of X may include a chlorine atom, a bromine atom, and an iodine atom.

The alkyl group optionally having a substituent and the aryl group optionally having a substituent of X may be optionally selected from the ranges enumerated as the alkyl group optionally having a substituent and the aryl group optionally having a substituent of R³, respectively.

Examples of the alkylsilyl group of X may include a trimethylsilyl group, a triethylsilyl group, and a t-butyldimethylsilyl group.

When the metal compound represented by the formula (1) has 2 or more X's in one molecule, those X's may be the same as or different from each other. Furthermore, the 2 or more X's may be bonded to each other to form a cyclic structure.

In the formula (1), L is an electron-donating neutral ligand.

Examples of the electron-donating neutral ligand of L may include an electron-donating compound which contains an atom of group 14 or 15 in the periodic table. Specific examples thereof may include: phosphines, such as trimethylphosphine, triisopropylphosphine, tricyclohexylphosphine, and triphenylphosphine; ethers, such as diethyl ether, dibutyl ether, 1,2-dimethoxyethane, and tetrahydrofuran; and amines, such as trimethylamine, triethylamine, pyridine, and lutidine. Among these, ethers are preferable. When the metal compound represented by the formula (1) has 2 or more L's in one molecule, those L's may be the same as or different from each other.

The metal compound represented by the formula (1) is preferably a tungsten compound having a phenyl imido group. That is, a compound of the formula (1) in which M is a tungsten atom, and R¹ is a phenyl group is preferable. Furthermore, among such compounds, a tetrachlorotungsten phenylimide (tetrahydrofuran) complex is more preferable.

The method for producing the metal compound represented by the formula (1) is not particularly limited. For example, the metal compound represented by the formula (1) may be produced by, as described in Japanese Patent Application Laid-Open No. Hei. 5-345817 A, mixing: an oxyhalide of the transition metal of group 6; phenyl isocyanates optionally having a substituent at one of 3-position, 4-position, and 5-position, or monosubstituted methyl isocyanates; an electron-donating neutral ligand (L); and as necessary, alcohols, metal alkoxide, and metal aryloxide.

In the aforementioned production method, the metal compound represented by the formula (1) is usually obtained in a state of being contained in a reaction solution. After the metal compound has been produced, the reaction solution as it is may be used as the catalyst solution for a ring-opening polymerization reaction. Alternatively, the metal compound may be isolated from the reaction solution and purified by a purification treatment such as crystallization, and the resulting metal compound may be used in the ring-opening polymerization reaction.

As the ring-opening polymerization catalyst, the metal compound represented by the formula (1) may be used alone. Alternatively, the metal compound represented by the formula (1) may be used in combination with another component. For example, polymerization activity can be enhanced by using a combination of the metal compound represented by the formula (1) and an organometallic reducing agent.

Examples of the organometallic reducing agent may include an organometallic compound of group 1, group 2, group 12, group 13, or group 14 in the periodic table with a hydrocarbon group with 1 to 20 carbon atoms. Examples of such an organometallic compound may include: organic lithium, such as methyl lithium, n-butyl lithium, and phenyl lithium; organic magnesium, such as butyl ethyl magnesium, butyl octyl magnesium, dihexyl magnesium, ethyl magnesium chloride, n-butyl magnesium chloride, and allyl magnesium bromide; organic zinc, such as dimethyl zinc, diethyl zinc, and diphenyl zinc; organic aluminum, such as trimethyl aluminum, triethyl aluminum, triisobutyl aluminum, diethyl aluminum chloride, ethyl aluminum sesquichloride, ethyl aluminum dichloride, diethyl aluminum ethoxide, diisobutyl aluminum isobutoxide, ethyl aluminum diethoxide, and isobutyl aluminum diisobutoxide; and organic tin, such as tetramethyl tin, tetra(n-butyl) tin, and tetraphenyl tin. Among these, organic aluminum or organic tin is preferable. As the organometallic reducing agent, one type thereof may be solely used, and two or more types thereof may also be used in combination at any ratio.

The ring-opening polymerization reaction is usually performed in an organic solvent. The organic solvent to be used may be any of those which allow a ring-opened polymer and a hydrogenated product thereof to be dissolved or dispersed therein under a specific conditions, and do not inhibit the ring-opening polymerization reaction and the hydrogenation reaction. Examples of such an organic solvent may include: an aliphatic hydrocarbon solvent, such as pentane, hexane, and heptane; an alicyclic hydrocarbon solvent, such as cyclopentane, cyclohexane, methyl cyclohexane, dimethyl cyclohexane, trimethyl cyclohexane, ethyl cyclohexane, diethyl cyclohexane, decahydronaphthalene, bicycloheptane, tricyclodecane, hexahydroindene, and cyclooctane; an aromatic hydrocarbon solvent, such as benzene, toluene, and xylene; a halogen-based aliphatic hydrocarbon solvent, such as dichloromethane, chloroform, and 1,2-dichloroehane; a halogen-based aromatic hydrocarbon solvent, such as chlorobenzene and dichlorobenzene; a nitrogen-containing hydrocarbon solvent, such as nitromethane, nitrobenzene, and acetonitrile; an ether solvent, such as diethyl ether and tetrahydrofuran; and a mixed solvent thereof. Among these, as the organic solvent, an aromatic hydrocarbon solvent, an aliphatic hydrocarbon solvent, an alicyclic hydrocarbon solvent, and an ether solvent are preferable. As the organic solvent, one type thereof may be solely used, and two or more types thereof may also be used in combination at any ratio.

The ring-opening polymerization reaction may be initiated by, for example, mixing the cyclic olefin monomer, the metal compound represented by the formula (1), and as necessary, the organometallic reducing agent. The mixing order of these components is not particularly limited. For example, a solution containing the metal compound represented by the formula (1) and the organometallic reducing agent may be mixed in a solution containing the cyclic olefin monomer. Alternatively, a solution containing the cyclic olefin monomer and the metal compound represented by the formula (1) may be mixed in a solution containing the organometallic reducing agent. Furthermore, a solution containing the metal compound represented by the formula (1) may be mixed in a solution containing the cyclic olefin monomer and the organometallic reducing agent. When each component is mixed, the total quantity of the component may be mixed at once, or the component may be divided for mixing over several times. Mixing may also be continuously performed over a relatively long period of time (for example, one minute or more).

The concentration of the cyclic olefin monomer in the reaction solution when the ring-opening polymerization reaction is initiated is preferably 1% by weight or more, more preferably 2% by weight or more, and particularly preferably 3% by weight or more, and is preferably 50% by weight or less, more preferably 45% by weight or less, and particularly preferably 40% by weight or less. When the concentration of the cyclic olefin monomer is equal to or more than the lower limit value of the aforementioned range, productivity can be increased. When the concentration is equal to or less than the upper limit value, the viscosity of the reaction solution after the ring-opening polymerization reaction can be decreased. Accordingly, a subsequent hydrogenation reaction can be easily performed.

The amount of the metal compound represented by the formula (1) used in the ring-opening polymerization reaction is desirably set such that the mole ratio of “metal compound:cyclic olefin monomer” falls within a specific range. Specifically, the molar ratio is preferably 1:100 to 1:2,000,000, more preferably 1:500 to 1,000,000, and particularly preferably 1:1,000 to 1:500,000. When the amount of the metal compound is equal to or more than the lower limit value of the aforementioned range, sufficient polymerization activity can be obtained. When the amount is equal to or less than the upper limit value, the metal compound can be easily removed after the reaction.

The amount of the organometallic reducing agent, relative to 1 mol of the metal compound represented by the formula (1), is preferably 0.1 mol or more, more preferably 0.2 mol or more, and particularly preferably 0.5 mol or more, and is preferably 100 mol or less, more preferably 50 mol or less, and particularly preferably 20 mol or less. When the amount of the organometallic reducing agent is equal to or more than the lower limit value of the aforementioned range, polymerization activity can be sufficiently increased. When the amount is equal to or less than the upper limit value, occurrence of a side reaction can be suppressed.

The polymerization reaction system of the polymer (α) may contain an activity adjuster. The use of the activity adjuster can stabilize the ring-opening polymerization catalyst, and also can achieve adjustment of the reaction rate of the ring-opening polymerization reaction and the molecular weight distribution of the polymer.

As the activity adjuster, an organic compound having a functional group may be used. Examples of such an activity adjuster may include an oxygen-containing compound, a nitrogen-containing compound, and a phosphorous-containing organic compound.

Examples of the oxygen-containing compound may include: ethers, such as diethyl ether, diisopropyl ether, dibutyl ether, anisole, furan, and tetrahydrofuran; ketones, such as acetone, benzophenone, and cyclohexanone; and esters, such as ethyl acetate.

Examples of the nitrogen-containing compound may include: nitriles, such as acetonitrile and benzonitrile; amines, such as triethylamine, triisopropylamine, quinuclidine, and N,N-diethylaniline; and pyridines, such as pyridine, 2,4-lutidine, 2,6-lutidine, and 2-t-butylpyridine.

Examples of the phosphorous-containing compound may include: phosphines, such as triphenylphosphine, tricyclohexylphosphine, triphenyl phosphate, and trimethyl phosphate; and phosphine oxides, such as triphenylphosphine oxide.

As the activity adjuster, one type thereof may be solely used, and two or more types thereof may also be used in combination at any ratio.

The amount of the activity adjuster in the polymerization reaction system of the polymer (α), relative to 100 mol % of the metal compound represented by the formula (1), is preferably 0.01 mol % to 100 mol %.

The polymerization reaction system of the polymer (α) may contain a molecular weight adjuster for adjusting the molecular weight of the polymer (α). Examples of the molecular weight adjuster may include: α-olefins, such as 1-butene, 1-pentene, 1-hexene, and 1-octene; an aromatic vinyl compound, such as styrene and vinyl toluene; an oxygen-containing vinyl compound, such as ethyl vinyl ether, isobutyl vinyl ether, allyl glycidyl ether, allyl acetate, allyl alcohol, and glycidyl methacrylate; a halogen-containing vinyl compound, such as allyl chloride; a nitrogen-containing vinyl compound, such as acrylamide; non-conjugated diene, such as 1,4-pentadiene, 1,4-hexadiene, 1,5-hexadiene, 1,6-heptadiene, 2-methyl-1,4-pentadiene, and 2,5-dimethyl-1,5-hexadiene; and conjugated diene, such as 1,3-butadiene, 2-methyl-1,3-butadiene, 2,3-dimethyl-1,3-butadiene, 1,3-pentadiene, and 1,3-hexadiene.

As the molecular weight adjuster, one type thereof may be solely used, and two or more types thereof may also be used in combination at any ratio.

The amount of the molecular weight adjuster in the polymerization reaction system for polymerizing the polymer (α) may be appropriately determined depending on an intended molecular weight. The specific amount of the molecular weight adjuster, relative to 100 mol % of the cyclic olefin monomer, is preferably in the range of 0.1 mol % to 50 mol %.

The polymerization temperature is preferably −78° C. or higher, and more preferably −30° C. or higher, and is preferably +200° C. or lower, and more preferably +180° C. or lower.

The polymerization time may be dependent on the reaction scale. The specific polymerization time is preferably in the range of 1 minute to 1000 hours.

By the aforementioned production method, the polymer (α) may be obtained. By hydrogenating this polymer (α), the polymer (β) may be produced.

The hydrogenation of the polymer (α) may be performed by, for example, supplying hydrogen into a reaction system containing the polymer (α), in the presence of a hydrogenation catalyst, according to a conventional method. Provided that the reaction conditions are appropriately set in this hydrogenation reaction, usually the tacticity of the hydrogenated product is not changed by the hydrogenation reaction.

As the hydrogenation catalyst, a homogeneous catalyst and a heterogeneous catalyst which are known as a hydrogenation catalyst of an olefin compound may be used.

Examples of the homogeneous catalyst may include: a catalyst which is formed of a combination of a transition metal compound and an alkali metal compound, such as cobalt acetate/triethyl aluminum, nickel acetylacetonate/triisobutyl aluminum, titanocene dichloride/n-butyl lithium, zirconocene dichloride/sec-butyl lithium, and tetrabutoxy titanate/dimethyl magnesium; and a noble metal complex catalyst such as dichlorobis(triphenylphosphine) palladium, chlorohydridecarbonyltris(triphenylphosphine) ruthenium, chlorohydridecarbonylbis(tricyclohexylphosphine) ruthenium, bis(tricyclohexylphosphine)benzylidine ruthenium (IV) dichloride, and chlorotris(triphenylphosphine) rhodium.

Examples of the heterogeneous catalyst may include: a metal catalyst, such as nickel, palladium, platinum, rhodium, and ruthenium; and a solid catalyst obtained by allowing the aforementioned metal to be carried by a carrier, such as carbon, silica, diatomaceous earth, alumina, and titanium oxide, such as nickel/silica, nickel/diatomaceous earth, nickel/alumina, palladium/carbon, palladium/silica, palladium/diatomaceous earth, and palladium/alumina.

As the hydrogenation catalyst, one type thereof may be solely used, and two or more types thereof may also be used in combination at any ratio.

The hydrogenation reaction is usually performed in an inactive organic solvent. Examples of the inactive organic solvent may include: an aromatic hydrocarbon solvent, such as benzene and toluene; an aliphatic hydrocarbon solvent, such as pentane and hexane; an alicyclic hydrocarbon solvent, such as cyclohexane and decahydronaphthalene; and an ether solvent, such as tetrahydrofuran and ethylene glycol dimethyl ether. As the inactive organic solvent, one type thereof may be solely used, and two or more types thereof may also be used in combination at any ratio. The inactive organic solvent may be the same as or different from the organic solvent used in the ring-opening polymerization reaction. Furthermore, the hydrogenation reaction may be performed by mixing the hydrogenation catalyst in the reaction solution of the ring-opening polymerization reaction.

The reaction conditions for the hydrogenation reaction usually vary depending on used hydrogenation catalysts.

The reaction temperature of the hydrogenation reaction is preferably −20° C. or higher, more preferably −10° C. or higher, and particularly preferably 0° C. or higher, and is preferably +250° C. or lower, more preferably +220° C. or lower, and particularly preferably +200° C. or lower. When the reaction temperature is equal to or higher than the lower limit value of the aforementioned range, the reaction rate can be increased. When the reaction temperature is equal to or lower than the upper limit value, occurrence of a side reaction can be suppressed.

The hydrogen pressure is preferably 0.01 MPa or more, more preferably 0.05 MPa or more, and particularly preferably 0.1 MPa or more, and is preferably 20 MPa or less, more preferably 15 MPa or less, and particularly preferably 10 MPa or less. When the hydrogen pressure is equal to or more than the lower limit value of the aforementioned range, the reaction rate can be increased. When the hydrogen pressure is equal to or less than the upper limit value, a special apparatus such as a highly pressure-resistant reaction apparatus is not required, thereby suppressing facility costs.

The reaction time of the hydrogenation reaction may be set to any period of time whereby a desired hydrogenation ratio is achieved, and preferably 0.1 hours to 10 hours.

After the hydrogenation reaction, the polymer (β), which is the hydrogenated product of the polymer (α), is usually recovered according to a conventional method.

The hydrogenation ratio (the ratio of a hydrogenated main chain double bond) in the hydrogenation reaction is preferably 98% or more, and more preferably 99% or more. The higher the hydrogenation ratio is, the more favorable the heat resistance of the crystallizable alicyclic olefin polymer can be.

Here, the hydrogenation ratio of the polymer may be measured by a ¹H-NMR measurement at 145° C., with ortho-dichlorobenzene-d⁴ as a solvent.

Subsequently, the method for producing the polymer (γ) and the polymer (δ) will be described.

The cyclic olefin monomer to be used for producing the polymers (γ) and (δ) may be optionally selected from the range enumerated as the cyclic olefin monomers to be used for producing the polymers (α) and (β). As the cyclic olefin monomer, one type thereof may be solely used, and two or more types thereof may also be used in combination at any ratio.

In the production of the polymer (γ), an optional monomer which is copolymerizable with the cyclic olefin monomer may be used as a monomer, in combination with the cyclic olefin monomer. Examples of the optional monomer may include: α-olefin with 2 to 20 carbon atoms, such as ethylene, propylene, 1-butene, 1-pentene, and 1-hexene; an aromatic ring vinyl compound, such as styrene and α-methylstyrene; and non-conjugated diene, such as 1,4-hexadiene, 4-methyl-1,4-hexadiene, 5-methyl-1,4-hexadiene, and 1,7-octadiene. Among these, α-olefin is preferable, and ethylene is more preferable. As the optional monomer, one type thereof may be solely used, and two or more types thereof may also be used in combination at any ratio.

The ratio between the cyclic olefin monomer and the optional monomer in terms of a weight ratio (cyclic olefin monomer:optional monomer) is preferably 30:70 to 99:1, more preferably 50:50 to 97:3, and particularly preferably 70:30 to 95:5.

In a case wherein two or more cyclic olefin monomers are used, and in a case wherein the cyclic olefin monomers and the optional monomer are used in combination, the polymer (γ) may be a block copolymer or a random copolymer.

For synthesizing the polymer (γ), an addition polymerization catalyst is usually used. Examples of such an addition polymerization catalyst may include a vanadium-based catalyst formed with a vanadium compound and an organoaluminum compound, a titanium-based catalyst formed with a titanium compound and an organoaluminum compound, and a zirconium-based catalyst formed with a zirconium complex and aluminoxane. As the addition polymerization catalyst, one type thereof may be solely used, and two or more types thereof may also be used in combination at any ratio.

The amount of the addition polymerization catalyst relative to 1 mol of the monomer is preferably 0.000001 mol or more, and more preferably 0.00001 mol or more, and is preferably 0.1 mol or less, and more preferably 0.01 mol or less.

The addition polymerization of the cyclic olefin monomer is usually performed in an organic solvent. The organic solvent may be optionally selected from the range enumerated as the organic solvents which may be used for the ring-opening polymerization of the cyclic olefin monomer. As the organic solvent, one type thereof may be solely used, and two or more types thereof may also be used in combination at any ratio.

The polymerization temperature in the polymerization for producing the polymer (γ) is preferably −50° C. or higher, more preferably −30° C. or higher, and particularly preferably −20° C. or higher, and is preferably 250° C. or lower, more preferably 200° C. or lower, and particularly preferably 150° C. or lower. The polymerization time is preferably 30 minutes or more, and more preferably 1 hour or more, and is preferably 20 hours or less, and more preferably 10 hours or less.

By the aforementioned production method, the polymer (γ) may be obtained. By hydrogenating this polymer (γ), the polymer (δ) may be produced.

The hydrogenation of the polymer (γ) may be performed by the same method as the method previously described as a method for hydrogenating the polymer (α).

In the first surface layer, the amount of the crystallizable alicyclic structure polymer in the crystallizable resin is preferably 90.0% by weight to 100% by weight, and more preferably 95.0% by weight to 100% by weight. When the amount of the crystallizable alicyclic structure polymer falls within the aforementioned range, chemical resistance and bending resistance of the optical layered body can be effectively enhanced.

The crystallizable resin which forms the first surface layer may further contain an optional component, in addition to the crystallizable alicyclic structure polymer. Examples of the optional component may include compounding agents such as: a coloring agent such as a pigment and a dye; a nucleating agent; a plasticizer; a fluorescent brightener; a dispersant; a thermal stabilizer; a light stabilizer; an antistatic agent; an antioxidant; and a surfactant. As the optional component, one type thereof may be solely used, and two or more types thereof may also be used in combination at any ratio.

The thickness of the first surface layer is preferably 0.1 μm or more, more preferably 0.2 μm or more, and particularly preferably 0.3 μm or more, and is preferably 5.0 μm or less, more preferably 4.0 μm or less, and particularly preferably 3.0 μm or less. When the thickness of the first surface layer is equal to or more than the lower limit value of the aforementioned range, the optical layered body can have favorable chemical resistance and bending resistance. Furthermore, the optical layered body can usually have improved heat resistance and scratch resistance. When the thickness of the first surface layer is equal to or less than the upper limit value of the aforementioned range, the liquid crystal display device including the optical layered body can have a favorable display quality when viewed through polarized sunglasses.

The ratio between the thickness of the substrate layer and the thickness of the first surface layer (first surface layer/substrate layer) is preferably 1/200 or more, more preferably 1/150 or more, and particularly preferably 1/100 or more, and is preferably 1/1.5 or less, more preferably 1/2.0 or less, and particularly preferably 1/2.5 or less. When the thickness ratio between the substrate layer and the first surface layer is equal to or more than the lower limit value of the aforementioned range, the optical layered body can have favorable chemical resistance and bending resistance. Furthermore, the optical layered body can usually have improved heat resistance and scratch resistance. When the thickness ratio is equal to or less than the upper limit value of the aforementioned range, the liquid crystal display device including the optical layered body can have a favorable display quality when viewed through polarized sunglasses.

When the optical layered body has a long-length shape, and the first surface layer has a slow axis, the slow axis of the first surface layer is preferably in a diagonal direction which is neither parallel to nor perpendicular to the longitudinal direction of the optical layered body. In particular, the orientation angle θ of the first surface layer relative to the longitudinal direction of the optical layered body is preferably 45°±5°. More particularly, the orientation angle θ of the first surface layer is preferably 40° or more, more preferably 43° or more, and particularly preferably 44° or more, and is preferably 50° or less, more preferably 47° or less, and particularly preferably 46° or less. Accordingly, when bonding the optical layered body and the polarizer to produce the polarizing plate, an angle between the slow axis of the optical layered body and the polarized light transmission axis of the polarizer can be easily adjusted.

[1.4. Second Surface Layer]

The second surface layer contains the crystallizable alicyclic structure polymer. Therefore, the second surface layer is usually a resin layer which is formed of the crystallizable resin. By including the second surface layer in combination with the first surface layer, the optical layered body can exert excellent characteristics such as chemical resistance and scratch resistance on both surfaces of the optical layered body. Furthermore, the optical layered body can have significantly enhanced bending resistance and heat resistance.

As the crystallizable resin which forms the second surface layer, those in the range described as the crystallizable resin which forms the first surface layer may be optionally used. The crystallizable resin which forms the second surface layer and the crystallizable resin which forms the first surface layer may be different from each other. However, it is preferable that they are the same from the viewpoint of reducing the production cost of the optical layered body and the curling.

The thickness of the second surface layer may be optionally set at a thickness within the range described as the thickness of the first surface layer. The thickness of the second surface layer and the thickness of the first surface layer may be different from each other. However, it is preferable that they are the same from the viewpoint of reducing the curling of the optical layered body.

When the optical layered body has a long-length shape, and the second surface layer has a slow axis, the slow axis of the second surface layer is preferably in a diagonal direction which is neither parallel to nor perpendicular to the longitudinal direction of the optical layered body. In particular, the orientation angle θ of the second surface layer relative to the longitudinal direction of the optical layered body is preferably set in the same range as that for the orientation angle θ of the first surface layer. Accordingly, when bonding the optical layered body and the polarizer to produce the polarizing plate, an angle between the slow axis of the optical layered body and the polarized light transmission axis of the polarizer can be easily adjusted.

[1.5. Optional Layer]

The optical layered body may include an optional layer as necessary, in combination with the substrate layer, the first surface layer and the second surface layer described above. For example, the optical layered body may include an optional resin layer between the substrate layer and the first surface layer, and may include an optional resin layer between the substrate layer and the second surface layer. For example, the optical layered body may include a hard coat layer, a conductive layer, or a combination thereof, on the first surface layer opposite the substrate layer. Alternatively, the optical layered body may include a layer which has both the function of the hard coat layer and the function of the conductive layer. As the conductive layer, a layer having transmittance in the visible light region, and also having conductivity may be adopted. Examples of the material for constituting the conductive layer may include a conductive polymer, a conductive paste, and metal oxide. More specific examples of the material may include a silver paste, a polymer paste, metal oxides, such as tin-doped indium oxide (ITO), antimony-doped or fluorine-doped tin oxide (ATO or FTO), aluminum-doped zinc oxide (AZO), cadmium oxide, oxide of cadmium and tin, titanium oxide, zinc oxide, and copper iodide, metals such as gold (Au), silver (Ag), platinum (Pt), and palladium (Pd), metal colloids which contain gold, copper, or the like, and inorganic or organic nanomaterials such as silver nanowires and carbon nanotubes (hereinafter, CNT). Therefore, the optical layered body is a two-layered structure film which includes the substrate layer and the first surface layer, a three-layered structure film which includes the first surface layer, the substrate layer and the second surface layer in this order, or a film which includes an optional layer in addition to these layers.

[1.6. Properties and Thickness of Optical Layered Body]

The retardation Re of the optical layered body is preferably 400 nm or less, more preferably 250 nm or less, and particularly preferably 180 nm or less. When the retardation of the optical layered body falls within the aforementioned range, the liquid crystal display device including the optical layered body can have a effectively enhanced display quality when viewed through polarized sunglasses. Specifically, rainbow-like color unevenness and darkening of the liquid crystal display device can be effectively suppressed. The lower limit value of the retardation of the optical layered body is preferably 80 nm or more, more preferably 85 nm or more, and particularly preferably 90 nm or more. When the retardation of the optical layered body is equal to or more than the lower limit value, the optical layered body can function as a ¼ wave plate. Consequently, use of this optical layered body can bring about conversion of linearly polarized light into circularly polarized light. Therefore, the aforementioned liquid crystal display device including the optical layered body can display an image with circularly polarized light. Thus, an image displayed on the liquid crystal display device can have favorable brightness and further enhance its display quality when viewed through polarized sunglasses.

The slow axis direction of the optical layered body may be optionally set depending on an intended use of the optical layered body. When the optical layered body has a long-length shape, the slow axis of the optical layered body is preferably in a diagonal direction which is neither parallel to nor perpendicular to the longitudinal direction of the optical layered body. In particular, the orientation angle θ of the optical layered body relative to the longitudinal direction of the optical layered body is preferably 45°±5°. More particularly, the aforementioned orientation angle θ of the optical layered body is preferably 40° or more, more preferably 43° or more, and particularly preferably 44° or more, and is preferably 50° or less, more preferably 47° or less, and particularly preferably 46° or less. Usually, when producing a polarizing plate, a polarizer having a long-length shape and an optical layered body having a long-length shape are bonded such that their longitudinal directions are parallel to each other. The polarized light transmission axis of a polarizer is usually parallel to or perpendicular to the longitudinal direction of the polarizer. Therefore, when the optical layered body has the aforementioned orientation angle θ as previously described, bonding can be easily performed such that the polarized light transmission axis of the polarizer and the slow axis of the optical layered body form an angle of 45°±5°. In the polarizing plate produced in this manner, linearly polarized light that passes through the polarizer can be converted into circularly polarized light by the optical layered body. Therefore, by providing this polarizing plate to a liquid crystal display device, a liquid crystal display device of which an image can have favorable brightness even through polarized sunglasses can be easily achieved.

The total light transmittance of the optical layered body is preferably 85% to 100%, more preferably 87% to 100%, and particularly preferably 90% to 100%. The total light transmittance may be measured in accordance with JIS K0115 using a spectrophotometer.

The light transmittance at a wavelength of 380 nm of the optical layered body is preferably 10% or less, more preferably 8.0% or less, and particularly preferably 5.0% or less. The optical layered body having such a low light transmittance at a wavelength of 380 nm has an excellent ultraviolet-shielding ability. Therefore, according to such an optical layered body, durability of the polarizing plate including the optical layered body can be improved, and deterioration due to ultraviolet rays of a liquid crystal panel of the liquid crystal display device including the optical layered body can be suppressed.

The amount of a volatile component contained in the optical layered body is preferably 0.1% by weight or less, more preferably 0.05% by weight or less, and further preferably 0.02% by weight or less. When the amount of the volatile component falls within the aforementioned range, the size stability of the optical layered body can be improved, and the time-dependent change of optical characteristics such as a retardation can be reduced. Furthermore, deterioration of the polarizing plate and the liquid crystal display device including the optical layered body can be suppressed. Accordingly, a display on the liquid crystal display device can be maintained to be stable and favorable in a long period of time. Here, the volatile component is a substance which has a molecular weight of 200 or less. Examples of the volatile component may include a residual monomer and a solvent. The amount of the volatile component may be quantified as a sum of a substance having a molecular weight of 200 or less through analysis by gas chromatography.

The thickness of the optical layered body is preferably 10 μm or more, more preferably 15 μm or more, and particularly preferably 20 μm or more, and is preferably 50 μm or less, more preferably 40 μm or less, and particularly preferably 30 μm or less. When the thickness of the optical layered body is equal to or more than the lower limit value of the aforementioned range, a retardation in a desired range can be expressed in the optical layered body. When the thickness is equal to or less than the upper limit value of the aforementioned range, the thickness of the optical layered body can be reduced.

In general, it is difficult to control the orientation of the crystallizable alicyclic structure polymer. Accordingly, a liquid crystal display device including a prior-art film which contains a crystallizable alicyclic structure polymer had a tendency to have a degraded display quality when viewed through polarized sunglasses. Specifically, when the liquid crystal display device including a prior-art film is viewed through polarized sunglasses, the aforementioned non-uniform retardation sometimes caused rainbow-like color unevenness and local darkening. On the other hand, a liquid crystal display device including the aforementioned optical layered body can have a favorable display quality when viewed through polarized sunglasses, nevertheless the optical layered body includes the surface layer (the first surface layer or the second surface layer) which contains the crystallizable alicyclic structure polymer.

The aforementioned optical layered body includes the surface layer which includes the crystallizable alicyclic structure polymer having excellent chemical resistance, and therefore has excellent chemical resistance. Specifically, the optical layered body has low tendency to cause deformation even when brought into contact with limonene as a solvent.

Furthermore, since the aforementioned optical layered body includes the surface layer containing the crystallizable alicyclic structure polymer which has excellent mechanical strength and has low tendency to be damaged even when stress is applied, it has excellent bending resistance. Specifically, the optical layered body has low tendency to be ruptured even when bent.

Since the optical layered body usually includes the surface layer containing the crystallizable alicyclic structure polymer which is excellent in mechanical strength and heat resistance, it is excellent in scratch resistance and heat resistance.

[1.7. Method for Producing Optical Layered Body]

The method for producing the optical layered body is not limited. The optical layered body may be produced by, for example, a production method which includes a step of molding the amorphous resin and the crystallizable resin into a film shape.

Examples of the method for molding the resins may include a coextrusion method and a cocasting method. Among these molding methods, a coextrusion method is preferable, because it has excellent production efficiency and has low tendency to leave a residual volatile component in the optical layered body.

The coextrusion method includes an extrusion step of coextruding the amorphous resin and the crystallizable resin. In the extrusion step, each of the amorphous resin and the crystallizable resin is extruded into a layer shape in a melted state. Examples of the resin extrusion method may include a coextrusion T die method, a coextrusion inflation method, and a coextrusion lamination method. Among these, a coextrusion T die method is preferable. The coextrusion T die method includes a feed block system and a multi-manifold system, and a multi-manifold system is particularly preferable because therewith fluctuation thickness can be reduced.

In the extrusion step, the melting temperature of the resins to be extruded is preferably (Tg+80° C.) or higher, and more preferably (Tg+100° C.) or higher, and is preferably (Tg+180° C.) or lower, and more preferably (Tg+170° C.) or lower. As described herein, “Tg” represents the highest temperature among the glass transition temperatures of the polymers contained in the amorphous resin or the crystallizable resin (for example, amorphous alicyclic structure polymer and crystallizable alicyclic structure polymer). When the melting temperature of the resins to be extruded is equal to or more than the lower limit value of the aforementioned range, the fluidity of the resins can be sufficiently enhanced, thereby to achieve favorable molding properties. When the melting temperature is equal to or lower than the upper limit value, the deterioration of the resins can be suppressed.

In the extrusion step, the temperature of the resins in an extruder is preferably Tg to (Tg+100° C.) at a resin charging inlet, and preferably (Tg+50° C.) to (Tg+170° C.) at an outlet of an extruder. The die temperature is preferably (Tg+50° C.) to (Tg+170° C.)

Furthermore, the arithmetic average roughness of a die lip of a die used in the extrusion step is preferably 1.0 μm or less, more preferably 0.7 μm or less, and particularly preferably 0.5 μm or less. When the arithmetic average roughness of a die lip falls within the aforementioned range, streak defects of the optical layered body can be easily suppressed.

In the coextrusion method, melted resins in film shape extruded through a die lip are usually brought into intimate contact with a cooling roll for cooling, so that the resins are cured. At this time, examples of the method for bringing melted resins into intimate contact with a cooling roll may include an air knife system, a vacuum box system, and an electrostatic adhesion system.

The number of cooling rolls is not particularly limited, and is usually two or more. Examples of the configuration of disposing the cooling rolls may include straight line-type, Z-type, and L-type. At this time, the method of guiding the melted resins extruded through a die lip to the cooling rolls is not particularly limited.

By molding the amorphous resin and the crystallizable resin into a film shape as previously described, a multilayer film which includes a substrate layer formed of the amorphous resin and a first surface layer formed of the crystallizable resin may be obtained. This multilayer film as it is may be used as the optical layered body. Alternatively, this multilayer film may be stretched to obtain the optical layered body. Since the stretching usually causes a retardation to be generated in the multilayer film, the optical layered body having a desired retardation may be obtained by performing stretching. Furthermore, since the stretching usually can promote the crystallization of the crystallizable alicyclic structure polymer contained in the crystallizable resin while giving orientation to the crystallizable alicyclic structure polymer, chemical resistance and bending resistance can be further improved. In the following description, the multilayer film to be stretched may be appropriately referred to as a “pre-stretch layered body”.

The stretching to be performed may be a uniaxial stretching treatment in which a stretching treatment is performed only in one direction, or may be a biaxial stretching treatment in which a stretching treatment is performed in two different directions. The biaxial stretching treatment may be a simultaneous biaxial stretching treatment in which stretching treatments are simultaneously performed in two directions, or a sequential biaxial stretching treatment in which a stretching treatment in a certain direction is followed by another stretching treatment in another direction. Furthermore, the stretching to be performed may be any of a longitudinal stretching treatment in which a stretching treatment is performed in the longitudinal direction of the pre-stretch layered body, a lateral stretching treatment in which a stretching treatment is performed in the width direction of the pre-stretch layered body, and a diagonal stretching treatment in which a stretching treatment is performed in a direction that is neither parallel to nor perpendicular to the width direction of the pre-stretch layered body, or may be a combination thereof. Among these stretching treatments, a diagonal stretching treatment is preferable, because the orientation angle of the optical layered body can be easily set within a desired range. Examples of the system of a stretching treatment may include a roll system, a float system, and a tenter system.

The stretching temperature and the stretching ratio may be optionally set within the range that allows the optical layered body having a desired retardation to be obtained. Specifically, the stretching temperature is preferably (Tg−30° C.) or higher, and more preferably (Tg−10° C.) or higher, and is preferably (Tg+60° C.) or lower, and more preferably (Tg+50° C.) or lower. The stretch ratio is preferably 1.01 to 30 times, preferably 1.01 to 10 times, and more preferably 1.01 to 5 times.

The method for producing the optical layered body may further include an optional step in combination with the aforementioned steps. For example, a heating step may be performed to the stretched multilayer film. This further promotes the crystallization of the crystallizable resin, thereby further improving chemical resistance and bending resistance of the optical layered body.

In the heating step, crystallization usually proceeds while the crystallizable resin maintains its orientation state. The heating temperature in the heating step is preferably the temperature within a specific range. Specifically, the heating temperature is preferably equal to or higher than the glass transition temperature Tg of the crystallizable resin contained in the optical layered body, and equal to or lower than the melting point Tm of the crystallizable resin. Thereby crystallization of the crystallizable resin can effectively proceed. Furthermore, it is preferable to set the temperature at, within the specific temperature range, a level that accelerates the speed of the crystallization. For example, when the hydrogenated product of a ring-opened polymer of dicyclopentadiene is used as the crystallizable resin, the heating temperature in the heating step is preferably 110° C. or higher, and more preferably 120° C. or higher, and is preferably 240° C. or lower, and more preferably 220° C. or lower.

As the heating apparatus for heating the multilayer film, a heating device capable of raising the atmospheric temperature around the multilayer film is preferable because such a heating apparatus does not require contact with the multilayer film. Specific examples of the suitable heating apparatus may include an oven and a heating furnace.

Furthermore, the heating of the multilayer film in the heating step is preferably performed in a state in which two or more sides thereof are held so that the multilayer film is strained. Here, the state in which the multilayer film is strained refers to a state in which tension is applied to the multilayer film. However, a state in which the multilayer film is substantially stretched is not included in this state in which the multilayer film is strained. The state in which the multilayer film is substantially stretched usually refers to when the stretching ratio in any direction of the multilayer film becomes 1.1 times or more.

By heating the multilayer film in the state in which two or more sides are held so that the multilayer film is strained, the multilayer film can be prevented from deforming due to thermal shrinkage in a region between the held sides. At this time, for preventing the deformation in a wider area of the multilayer film, it is preferable that sides including two opposing sides are held so that a region between the held sides becomes in a strained state. For example, with a multilayer film of a rectangular sheet piece shape, it is preferable that two opposing sides (for example, opposing long sides or opposing short sides) are held so that a region between the two sides is in a strained state, thereby preventing deformation in the entire surface of the sheet piece shaped multilayer film. With a multilayer film having a long-length shape, it is preferable that two sides at ends in the width direction (that is, two long sides) are held so that a region between the two sides is in a strained state, thereby preventing deformation in the entire surface of the multilayer film having a long-length shape. In the multilayer film which is prevented from deforming in this manner, deformation such as wrinkles can be suppressed even when stress is generated due to thermal shrinkage in the film. Therefore, the multilayer film can be prevented from losing its smoothness due to heating. Thus, a smooth multilayer film in which waviness and wrinkles are reduced can be obtained.

Furthermore, for more reliably suppressing the deformation during heating, sides to be held are preferably as many as possible. Therefore, for example, with a multilayer film of a sheet piece shape, it is preferable that all sides of the film are held. Specifically, for example, with a multilayer film having a rectangular sheet piece shape, it is preferable that four sides are held.

When the multilayer film is held, the holding of the sides of the multilayer film may be performed with adequate holders. The holder may be a tool which is capable of continuously holding the entire length of the sides of the multilayer film, or a tool which is capable of holding the sides of the multilayer film intermittently with gaps. For example, sides of the multilayer film may be held intermittently with holders spaced apart at specific intervals.

It is preferable that the holders are not in contact with the multilayer film at portions other than the sides of the multilayer film. The use of such holders can provide the optical layered body having more excellent smoothness.

Furthermore, it is preferable that the holders are capable of fixing the relative positions thereof during the heating step. With such holders, the positions of the holders do not relatively move during the heating step. Accordingly, substantial stretching of the multilayer film during heating can be easily suppressed.

Examples of suitable holders for a rectangular multilayer film may include grippers such as clips which are disposed on a mold frame at a specific distance and are capable of gripping the sides of the multilayer film. Examples of holders for holding two sides at the ends in the width direction of the multilayer film having a long-length shape may include grippers which are disposed in a tenter stretching machine and are capable of gripping the sides of the multilayer film.

When the multilayer film having a long-length shape is used, sides at the ends in the longitudinal direction of the multilayer film (that is, short sides) may be held. However, instead of holding the aforementioned sides, both ends in the longitudinal direction of a region of the multilayer film to be heated to a specific temperature range may be held. For example, there may be disposed holding apparatuses which are capable of holding the multilayer film at both ends in the longitudinal direction of a region of the multilayer film to be heated to a specific temperature range in a manner of avoiding thermal shrinkage, so that the multilayer film becomes in a strained state. Examples of such a holding apparatus may include a combination of two rolls. By the combination, tension such as conveyance tension may be applied to the multilayer film, and the thermal shrinkage of the multilayer film in a region to be heated to a specific temperature range can be suppressed. Therefore, by using the combination as the holding apparatuses, the multilayer film can be held while being conveyed in the longitudinal direction, thereby achieving efficient production of the optical layered body.

The treatment time during which the multilayer film is maintained at a specific temperature range in the heating step is preferably 5 seconds or more, and more preferably 10 seconds or more, and is preferably 1 hour or less. This allows the crystallization of the crystallizable resin to sufficiently proceed. Thus, heat resistance, chemical resistance, and bending resistance of the optical layered body can be particularly enhanced.

[2. Polarizing Plate]

The polarizing plate according to the present invention includes a polarizer and the optical layered body disposed on at least one side of the polarizer.

As the polarizer, there can be used a film which can transmit one of two linearly polarized lights orthogonally intersecting each other and absorb or reflect the other. Specific examples of the polarizer may include a film of a vinyl alcohol-based polymer, such as polyvinyl alcohol and partially formalized polyvinyl alcohol which has been subjected to an appropriate treatment, such as a dyeing treatment with a dichromic substance such as iodine and a dichroic dye, a stretching treatment, and a crosslinking treatment, in an appropriate order and method. In particular, a polarizer which contains polyvinyl alcohol is preferable. The thickness of the polarizer is usually 5 μm to 80 μm.

When the optical layered body has a retardation, the polarized light transmission axis of the polarizer and the slow axis of the optical layered body in the polarizing plate preferably form an angle of 45°±5°. Accordingly, linearly polarized light which has passed the polarizer can be converted into circularly polarized light by the optical layered body.

The polarizing plate may be produced by bonding the optical layered body onto one side of the polarizer. An adhesive may be used as necessary for the bonding. When the polarizing plate is obtained by bonding the two-layer structure optical layered body including the substrate layer and the first surface layer to the polarizer, they are usually bonded together so that the polarizer, the substrate layer, and the first surface layer are disposed in this order.

The polarizing plate may further include an optional layer, in combination with the polarizer and the optical layered body. For example, the polarizing plate may include an optional protective film layer other than the optical layered body, for the protection of the polarizer. Such a protective film layer is usually provided on the surface of the polarizer opposite the optical layered body.

[3. Liquid Crystal Display Device]

The liquid crystal display device includes the polarizing plate according to the present invention. The liquid crystal display device usually includes a light source, a light source-side polarizing plate, a liquid crystal cell, and the polarizing plate in this order. The polarizing plate is disposed such that the polarizer and the optical layered body are disposed in this order from the light source side.

Since the liquid crystal display device according to the present invention includes the aforementioned optical layered body, it has a favorable display quality when viewed through polarized sunglasses. When the optical layered body has an appropriate retardation, such a liquid crystal display device can display an image with circularly polarized light. Consequently, the image can be bright even when viewed through polarized sunglasses.

Examples of a driving system of the liquid crystal cell may include an in-plane switching (IPS) mode, a vertical alignment (VA) mode, a multi-domain vertical alignment (MVA) mode, a continuous pinwheel alignment (CPA) mode, a hybrid alignment nematic (HAN) mode, a twisted nematic (TN) mode, a super-twisted nematic (STN) mode, and an optical compensated bend (OCB) mode.

### EXAMPLES

Hereinafter, the present invention will be specifically described by referring to Examples. However, the present invention is not limited to the following Examples, and may be freely modified and practiced without departing from the scope of claims of the present invention and the scope of their equivalents.

In the following description, “%” and “parts” indicating quantity are on the basis of weight, unless otherwise stated. Furthermore, the operation described hereinafter was performed at a normal temperature and normal pressure in an atmospheric air, unless otherwise stated.

[Evaluation Method]

(Method for Measuring Thickness of Layered Body)

The thickness of the layered body was measured using a contact-type film thickness meter (a dial gauge manufactured by Mitutoyo Corporation).

The thickness of each layer contained in the layered body was measured by embedding the layered body in an epoxy resin, and thereafter slicing the obtained product to be in a shape having a thickness of 0.05 μm using a microtome and observing the cross section using a microscope.

(Method for Measuring Light Transmittance of Optical Layered Body)

The light transmittance of the optical layered body at a wavelength of 380 nm was measured in accordance with JIS K 0115 (General rules for molecular absorptiometric analysis) using a spectrophotometer (ultraviolet visible near-infrared spectrophotometer “V-650” manufactured by Jasco Corporation).

(Method for Measuring Haze of Optical Layered Body)

In accordance with JIS K 7136, the haze of a 50 mm×50 mm film piece which had been cut out from the optical layered body was obtained.

(Method for Measuring in-Plane Retardation of Optical Layered Body)

The in-plane retardation of the optical layered body at a wavelength of 550 nm was measured using a poralimeter (“Axoscan” manufactured by Axiometric, Inc.).

(Method for Measuring Orientation Angle θ of Optical Layered Body)

The orientation angle θ of the optical layered body relative to the longitudinal direction of the optical layered body was measured at a wavelength of 550 nm using a poralimeter (“Axoscan” manufactured by Axiometric, Inc.).

(Method for Evaluating Bending Resistance of Optical Layered Body)

The bending resistance of the optical layered body was measured in the following procedure, by an MIT folding endurance test in accordance with JIS P 8115 “Paper and board—determination of folding endurance—MIT method”.

From the optical layered body as a sample, a test piece having a width of 15 mm±0.1 mm and a length of 110 mm was cut out. In this operation, when the optical layered body was the one which had been produced through the stretching step, the test piece was produced such that the orientation direction of the polymer molecules contained in the optical layered body becomes parallel to the side having a length of 110 mm of the test piece. When the optical layered body was the one which had been produced without the stretching step, the test piece was produced such that the flow direction in the extrusion step (that is, the longitudinal direction of the film obtained in the extrusion step) becomes parallel to the side having a length of 110 mm of the test piece.

Using an MIT folding endurance tester (“No. 307” manufactured by Yasuda Seiki Seisakusho, Ltd.), the aforementioned test piece was bent such that a bending line appears in the width direction of the test piece under the conditions of a load of 9.8 N, a bending portion curvature of 0.38±0.02 mm, a bending angle of 135°±2°, and a bending rate of 175 times/minute. Each test piece was bent such that the surface layer formed of the crystallizable resin faces outward. This bending was repeated, and the number of reciprocating bendings until the test piece was ruptured was measured.

Ten test pieces were produced, and the number of reciprocating bendings until the test piece was ruptured was measured ten times. An average for the ten measured values was adopted as the folding endurance (MIT folding endurance counts) of the tested optical layered body.

When the folding endurance was 2000 times or more, “4” was assigned as an evaluation, indicating that the bending resistance is the most favorable. When the folding endurance was less than 2000 times and equal to or more than 1000 times, “3” was assigned as an evaluation, indicating that the bending resistance is particularly favorable. When the folding endurance was less than 1000 times and equal to or more than 500 times, “2” was assigned as an evaluation, indicating that the bending resistance is favorable. When the folding endurance was less than 500 times, “1” was assigned as an evaluation, indicating that the bending resistance is poor.

(Method for Evaluating Chemical Resistance of Optical Layered Body)

The optical layered body was curved with a bending diameter φ of 10 mm such that the surface layer formed of the crystallizable resin faces outward. 1 cc of limonene was dropped on the outward surface of the curved portion, and wiped off after the lapse of 30 seconds.

When deformation was not observed on the surface, “3” was assigned as an evaluation, indicating that the chemical resistance is particularly favorable.

When the surface was slightly deformed, “2” was assigned as an evaluation, indicating that the chemical resistance is favorable. Furthermore, when a crack was observed on the surface, “1” was assigned as an evaluation, indicating that the chemical resistance is poor.

When deformation was not observed, the optical layered body was further curved with a bending diameter φ of 3 mm while the surface wiped off was faced outward. When a fracture was not generated at this time, “4” was assigned as an evaluation, indicating that the chemical resistance is the most favorable.

(Method for Durability Test of Polarizing Plate)

Using an ultraviolet light fade meter U48 (manufactured by Suga Test Instruments Co., Ltd.), the polarizing plate was exposed to ultraviolet rays for 500 hours under the conditions of an irradiance of 500 W/m², a temperature of 63±3° C., and a humidity of 50% RH or less. Thereafter, the presence or absence of discoloration was visually observed. When discoloration was not observed, “3” was assigned as an evaluation, indicating that the durability is particularly favorable. When discoloration was slightly observed, “2” was assigned as an evaluation, indicating that the durability is favorable. Furthermore, when discoloration was significantly observed, “1” was assigned as an evaluation, indicating that the durability is poor.

(Method for Evaluating Display Quality of Liquid Crystal Display Device)

The display surface of the liquid crystal display device was observed through polarized sunglasses, while changing the position of the liquid crystal display device. When rainbow-like color unevenness was not observed, and an image was visually recognizable in a clear manner, “3” was assigned as an evaluation, indicating that the display quality is particularly favorable. When rainbow-like color unevenness was slightly observed, or an image was somewhat dark, “2” was assigned as an evaluation, indicating that the display quality is favorable. Furthermore, when rainbow-like color unevenness was clearly recognizable, or an image was significantly dark, “1” was assigned as an evaluation, indicating that the clarity of an image is poor.

### Production Example 1: Production of Amorphous Alicyclic Structure Polymer A1

A mixture containing tricyclo[4.3.0.1^{2,5}]dec-3,7-diene (common name: dicyclopentadiene, hereinafter appropriately abbreviated to “DCP”), 7,8-benzotricyclo[4.3.0.1^{2,5}]dec-3-ene (common name: methanotetrahydrofluorene, hereinafter appropriately abbreviated to “MTF”), and tetracyclo[4.4.0.1^{2,5}.1^{7,10}]dodeca-3-ene (common name: tetracyclododecene, hereinafter appropriately abbreviated to “TCD”), at a mixing weight ratio of DCP/MTF/TCD=60/10/30 was prepared. This mixture was ring-opening polymerized by a publicly known method, and subsequently hydrogenated. Thus, an amorphous alicyclic structure polymer was obtained. The composition of norbornene-based monomers remaining in the reaction solution after polymerization was examined through analysis by gas chromatography, to obtain the copolymerization ratio of each norbornene-based monomer in the obtained amorphous alicyclic structure polymer. As a result, the copolymerization ratio in the amorphous alicyclic structure polymer was DCP/MTF/TCD=60/10/30, which was approximately equal to the charging composition. The amorphous alicyclic structure polymer had a weight-average molecular weight (Mw) of 35,000, a molecular weight distribution (Mw/Mn) of 2.1, a hydrogenation rate of 99.9%, a glass transition temperature Tg of 125° C., and a refractive index at 25° C. of 1.53.

### Production Example 2: Production of Crystallizable Alicyclic Structure Polymer

A metal pressure resistant reaction vessel was sufficiently dried. Thereafter, the air in the vessel was substituted with nitrogen. Into this metal pressure resistant reaction vessel, 154.5 parts of cyclohexane, 42.8 parts (30 parts as the amount of dicyclopentadiene) of a 70% cyclohexane solution of dicyclopentadiene (endo form content: 99% or more), and 1.9 parts of 1-hexene were poured. The mixture was heated to 53° C.

0.061 parts of a 19% diethylaluminum ethoxide/n-hexane solution was added to a solution in which 0.014 parts of a tetrachlorotungsten phenylimide (tetrahydrofuran) complex was dissolved in 0.70 parts of toluene. The mixture was stirred for 10 minutes to prepare a catalyst solution.

This catalyst solution was poured into the pressure resistant reaction vessel to initiate a ring-opening polymerization reaction. Thereafter, the reaction was allowed to proceed for 4 hours while 53° C. was maintained. Thus, a solution of a ring-opened polymer of dicyclopentadiene was obtained.

The number-average molecular weight (Mn) and weight-average molecular weight (Mw) of the obtained ring-opened polymer of dicyclopentadiene were 8,750 and 28,100, respectively. The molecular weight distribution (Mw/Mn) calculated from these values was 3.21.

To 200 parts of the solution of the obtained ring-opened polymer of dicyclopentadiene, 0.037 parts of 1,2-ethanediol was added as a terminator. The obtained product was heated to 60° C. and stirred for one hour to terminate the polymerization reaction. To the obtained product, 1 part of a hydrotalcite-like compound (“Kyoward (registered trademark) 2000” manufactured by Kyowa Chemical Industry Co., Ltd.) was added. The mixture was heated to 60° C., and stirred for one hour. Thereafter, 0.4 parts of a filter aid (“Radiolite (registered trademark) #1500” manufactured by Showa Chemical Industry Co., Ltd.) was added thereto, and the adsorbent and the solution were separated by filtering using a PP pleated cartridge filter (“TCP-HX” manufactured by Advantec Toyo Kaisha Ltd.).

To 200 parts (polymer amount: 30 parts) of the filtrated solution of the ring-opened polymer of dicyclopentadiene, 100 parts of cyclohexane were added. Then, 0.0043 parts of chlorohydridocarbonyl tris(triphenylphosphine)ruthenium was added thereto, and a hydrogenation reaction was performed at a hydrogen pressure of 6 MPa and a temperature of 180° C. for 4 hours. Thus, a reaction solution which contained a hydrogenated product of the ring-opened polymer of dicyclopentadiene was obtained. In this reaction solution, the hydrogenated product was deposited to render the solution a slurry.

The hydrogenated product contained in the aforementioned reaction solution was separated from the solution using a centrifugal separator, and dried under reduced pressure at 60° C. for 24 hours. Thus, 28.5 parts of a crystallizable alicyclic structure polymer was obtained. This crystallizable alicyclic structure polymer had a hydrogenation rate of 99% or more, a glass transition temperature Tg of 93° C., a melting point (Tm) of 262° C., and a racemo diad ratio of 89%.

### Production Example 3: Production of Amorphous Alicyclic Structure Polymer A2

A mixture in which MTF and TCD were mixed at a weight ratio of MTF/TCD=60/40 was prepared. This mixture was ring-opening polymerized by a publicly known method, and subsequently hydrogenated. Thus, an amorphous alicyclic structure polymer was obtained. The composition of norbornene-based monomers remaining in the reaction solution after polymerization was examined through analysis by gas chromatography, to obtain the copolymerization ratio of each norbornene-based monomer in the obtained amorphous alicyclic structure polymer. As a result, the copolymerization ratio in the amorphous alicyclic structure polymer was MTF/TCD=60/40, which was approximately equal to the charging composition. The amorphous alicyclic structure polymer had a weight-average molecular weight (Mw) of 40,000, a molecular weight distribution (Mw/Mn) of 1.9, a hydrogenation rate of 99.9%, a glass transition temperature Tg of 163° C., and a refractive index at 25° C. of 1.53.

### Example 1

(1-1. Production of Amorphous Resin H1)

92 parts of the amorphous alicyclic structure polymer A1 produced in Production Example 1, 7.0 parts of a benzotriazole-based ultraviolet ray absorber (“LA-31” manufactured by Adeka Corporation), and 1.0 part of an antioxidant (tetrakis[methylene-3-(3′,5′-di-t-butyl-4′-hydroxyphenyl)propionate]methane; “Irganox (registered trademark) 1010” manufactured by BASF Japan Ltd.) were mixed by a biaxial extruder to obtain a mixture. The obtained mixture was charged into a hopper connected to the extruder, and supplied to a uniaxial extruder for melt extrusion. Thus, an amorphous resin H1 was obtained. The amount of the ultraviolet ray absorber in the amorphous resin H1 was 7.0% by weight.

(1-2. Production of Crystallizable Resin K1)

Into 100 parts of the crystallizable alicyclic structure polymer produced in the Production Example 2, 1.1 parts of an antioxidant (tetrakis[methylene-3-(3′,5′-di-t-butyl-4′-hydroxyphenyl)propionate]methane; “Irganox (registered trademark) 1010” manufactured by BASF Japan Ltd.) was mixed. Thus, a crystallizable resin K1 was obtained.

(1-3. Extrusion Step)

The amorphous resin H1 was charged into a hopper, and then supplied to a multi-manifold die.

Meanwhile, the crystallizable resin K1 was charged into another hopper, and then supplied to the aforementioned multi-manifold die.

Subsequently, the amorphous resin H1 and the crystallizable resin K1 were discharged from the multi-manifold die to be in a film shape, and cast on a cooling roll. By such a coextrusion method, a pre-stretch layered body 1 having a long-length shape, which included the first surface layer (thickness: 4.0 μm) formed of the crystallizable resin K1/the substrate layer (thickness: 32.0 μm) formed of the amorphous resin H1/the second surface layer (thickness: 4.0 μm) formed of the crystallizable resin K1 in this order was obtained. This pre-stretch layered body 1 was a film of two-type three-layers (i.e., film having a three-layer structure formed of two types of resins), and had a width of 1400 mm and a thickness of 40 μm. Thereafter, 50 mm of the pre-stretch layered body 1 was trimmed at each end so that the width became 1300 mm.

(1-4. Stretching Step)

The pre-stretch layered body 1 was supplied to a tenter apparatus which included clips capable of gripping both ends in the width direction of the pre-stretch layered body 1 and rails capable of guiding the clips. With this tenter apparatus, stretching was performed. When stretched, the rails of the tenter apparatus were set such that a slow axis having an angle of 45° relative to the longitudinal direction would be generated after the stretching. The stretching conditions were set to be a stretching temperature of 130° C. and a film conveyance speed of 20 m/min. As a result, an optical layered body 1 having a long-length shape, which included the first surface layer (thickness: 2.5 μm) formed of the crystallizable resin K1/the substrate layer (thickness: 20 μm) formed of the amorphous resin H1/the second surface layer (thickness: 2.5 μm) formed of the crystallizable resin K1 in this order was obtained. This optical layered body 1 was a film of two-type three-layers, and had a width of 1330 mm and a thickness of 25 μm.

The optical layered body 1 was evaluated for its in-plane retardation, orientation angle θ, haze, light transmittance at a wavelength of 380 nm, bending resistance, and chemical resistance by the aforementioned methods.

(1-5. Production of Polarizing Plate)

A polarizer produced by doping a raw material film with iodine and stretching the doped film in one direction was prepared. The optical layered body 1 was bonded to one surface of this polarizer with an ultraviolet-curable acrylic adhesive. Furthermore, a cycloolefin film having been subjected to lateral uniaxial stretching was bonded to the other surface of the polarizer with an ultraviolet-curable acrylic adhesive. Then, the obtained product was irradiated with ultraviolet rays to obtain a polarizing plate 1. In this operation, the slow axis of the optical layered body 1 was set such that it formed an angle of 45° relative to the polarized light transmission axis of the polarizer. The slow axis of the cycloolefin film was set such that it was parallel to the polarized light transmission axis of the polarizer. A durability test was performed for the obtained polarizing plate 1 by the aforementioned method.

(1-6. Production of Liquid Crystal Display Device)

The viewing-side polarizing plate of a liquid crystal panel equipped with a publicly known in-cell type touch sensor was removed, and the polarizing plate 1 was installed instead. Thus, a liquid crystal display device 1 was produced. In this operation, the orientation of the polarizing plate 1 was set such that the surface on the first surface layer side faced the viewing side. The obtained liquid crystal display device 1 was evaluated for its display quality by the aforementioned method.

### Example 2

(2-1. Production of Amorphous Resin H2)

An amorphous resin H2 was produced in the same manner as that in step (1-1) of Example 1, except that the addition amount of the ultraviolet ray absorber was 0% by weight.

(2-2. Extrusion Step and Stretching Step)

An optical layered body 2 was produced in the same manner as that in step (1-3) and step (1-4) of Example 1, except that the amorphous resin H2 was used in place of the amorphous resin H1. The optical layered body 2 was evaluated for its in-plane retardation, orientation angle θ, haze, light transmittance at a wavelength of 380 nm, bending resistance, and chemical resistance, by the aforementioned methods.

(2-3. Production of Polarizing Plate 2)

A polarizing plate 2 was produced in the same manner as that in step (1-5) of Example 1, except that the optical layered body 2 was used in place of the optical layered body 1. A durability test was performed for the obtained polarizing plate 2 by the aforementioned method.

(2-4. Production of Liquid Crystal Display Device 2)

A liquid crystal display device 2 was produced in the same manner as that in step (1-6) of Example 1, except that the polarizing plate 2 was used in place of the polarizing plate 1. The obtained liquid crystal display device 1 was evaluated for its display quality by the aforementioned method.

### Example 3

(3-1. Extrusion Step)

A pre-stretch layered body which included the first surface layer (thickness: 2.5 μm) formed of the crystallizable resin K1/the substrate layer (thickness: 20.0 μm) formed of the amorphous resin H1/the second surface layer (thickness: 2.5 μm) formed of the crystallizable resin K1 in this order was obtained in the same manner as that in step (1-3) of Example 1, except that the thickness of extruded resin was changed. This pre-stretch layered body which was not subjected to a stretching step was used as an optical layered body 3. The optical layered body 3 was evaluated for its in-plane retardation, orientation angle θ, haze, light transmittance at a wavelength of 380 nm, bending resistance, and chemical resistance, by the aforementioned methods.

(3-2. Production of Polarizing Plate 3)

A polarizing plate 3 was produced in the same manner as that in step (1-5) of Example 1, except that the optical layered body 3 was used in place of the optical layered body 1. A durability test was performed for the obtained polarizing plate 3 by the aforementioned method.

(3-3. Production of Liquid Crystal Display Device 3)

A liquid crystal display device 3 was produced in the same manner as that in step (1-6) of Example 1, except that the polarizing plate 3 was used in place of the polarizing plate 1. The obtained liquid crystal display device 3 was evaluated for its display quality by the aforementioned method.

### Example 4

(4-1. Extrusion Step)

A pre-stretch layered body 4 which included the first surface layer (thickness: 4.0 μm) formed of the crystallizable resin K1/the substrate layer (thickness: 32.0 μm) formed of the amorphous resin H2 was obtained in the same manner as that in step (1-3) of Example 1, except that the extrusion was changed such that not two layers but only one layer of the crystallizable resin K1 was extruded, and the amorphous resin H2 was used in place of the amorphous resin H1.

(4-2. Stretching Step)

An optical layered body 4 which included the first surface layer (thickness: 2.5 μm) formed of the crystallizable resin K1/the substrate layer (thickness: 20.0 μm) formed of the amorphous resin H2 was obtained in the same manner as that in step (1-4) of Example 1, except that the pre-stretch layered body 4 was used in place of the pre-stretch layered body 1. The optical layered body 4 was evaluated for its in-plane retardation, orientation angle θ, haze, light transmittance at a wavelength of 380 nm, bending resistance, and chemical resistance, by the aforementioned methods.

(4-3. Production of Polarizing Plate 4)

A polarizing plate 4 was produced in the same manner as that in step (1-5) of Example 1, except that the optical layered body 4 was used in place of the optical layered body 1. In this step, the optical layered body 4 was bonded to the polarizer at the surface on the substrate layer side. A durability test was performed for the obtained polarizing plate 4 by the aforementioned method.

(4-4. Production of Liquid Crystal Display Device 4)

A liquid crystal display device 4 was produced in the same manner as that in step (1-6) of Example 1, except that the polarizing plate 4 was used in place of the polarizing plate 1. The obtained liquid crystal display device 4 was evaluated for its display quality by the aforementioned method.

### Example 5

(5-1. Extrusion Step)

A pre-stretch layered body 5 which included the first surface layer (thickness: 12.0 μm) formed of the crystallizable resin K1/the substrate layer (thickness: 16.0 μm) formed of the amorphous resin H2/the second surface layer (thickness: 12.0 μm) formed of the crystallizable resin K1 in this order was obtained in the same manner as that in step (1-3) of Example 1, except that the thickness of extruded resin was changed, and the amorphous resin H2 was used in place of the amorphous resin H1.

(5-2. Stretching Step)

An optical layered body 5 which included the first surface layer (thickness: 7.5 μm) formed of the crystallizable resin K1/the substrate layer (thickness: 10.0 μm) formed of the amorphous resin H2/the second surface layer (thickness: 7.5 μm) formed of the crystallizable resin K1 in this order was obtained in the same manner as that in step (1-4) of Example 1, except that the pre-stretch layered body 5 was used in place of the pre-stretch layered body 1. The optical layered body 5 was evaluated for its in-plane retardation, orientation angle θ, haze, light transmittance at a wavelength of 380 nm, bending resistance, and chemical resistance, by the aforementioned methods.

(5-3. Production of Polarizing Plate 5)

A polarizing plate 5 was produced in the same manner as that in step (1-5) of Example 1, except that the optical layered body 5 was used in place of the optical layered body 1. A durability test was performed for the obtained polarizing plate 5 by the aforementioned method.

(5-4. Production of Liquid Crystal Display Device 5)

A liquid crystal display device 5 was produced in the same manner as that in step (1-6) of Example 1, except that the polarizing plate 5 was used in place of the polarizing plate 1. The obtained liquid crystal display device 5 was evaluated for its display quality by the aforementioned method.

### Example 6

(6-1. Extrusion Step)

A pre-stretch layered body 6 which included the first surface layer (thickness: 0.08 μm) formed of the crystallizable resin K1/the substrate layer (thickness: 40.0 μm) formed of the amorphous resin H2/the second surface layer (thickness: 0.08 μm) formed of the crystallizable resin K1 in this order was obtained in the same manner as that in step (1-3) of Example 1, except that the thickness of the extruded resin was changed, and the amorphous resin H2 was used in place of the amorphous resin H1.

(6-2. Stretching Step)

An optical layered body 6 which included the first surface layer (thickness: 0.05 μm) formed of the crystallizable resin K1/the substrate layer (thickness: 25.0 μm) formed of the amorphous resin H2/the second surface layer (thickness: 0.05 μm) formed of the crystallizable resin K1 in this order was obtained in the same manner as that in step (1-4) of Example 1, except that the pre-stretch layered body 6 was used in place of the pre-stretch layered body 1. The optical layered body 6 was evaluated for its in-plane retardation, orientation angle θ, haze, light transmittance at a wavelength of 380 nm, bending resistance, and chemical resistance, by the aforementioned methods.

(6-3. Production of Polarizing Plate 6)

A polarizing plate 6 was produced in the same manner as that in step (1-5) of Example 1, except that the optical layered body 6 was used in place of the optical layered body 1. A durability test was performed for the obtained polarizing plate 6 by the aforementioned method.

(6-4. Production of Liquid Crystal Display Device 6)

A liquid crystal display device 6 was produced in the same manner as that in step (1-6) of Example 1, except that the polarizing plate 6 was used in place of the polarizing plate 1. The obtained liquid crystal display device 6 was evaluated for its display quality by the aforementioned method.

### Example 7

(7-1. Production of Amorphous Resin H3)

An amorphous resin H3 was produced in the same manner as that in step (1-1) of Example 1, except that the amorphous resin polymer A2 produced in Production Example 3 was used in place of the amorphous alicyclic structure polymer A1.

(7-2. Extrusion Step)

A pre-stretch layered body 7 was obtained in the same manner as that in step (1-3) of Example 1, except that the amorphous resin H3 was used in place of the amorphous resin H1.

(7-3. Stretching Step)

A stretched layered body 7 was produced in the same manner as that in the production of the optical layered body 1 in step (1-4) of Example 1, except that the stretching temperature was set to be 165° C.

(7-4. Heating Step)

The stretched layered body 7 obtained in (7-3) was subjected to a heating treatment while conveyed in a state in which both ends of the stretched layered body 7 were held and strained by clips of a tenter stretching machine which was equipped with clips capable of carrying two sides at both ends of a long-length film. The heating conditions in this operation were a temperature of 175° C. and a treatment time of 20 minutes. This promoted the crystallization of the first surface layer formed from the crystallizable resin. Thus, an optical layered body 7 was obtained. The obtained optical layered body 7 was evaluated for its in-plane retardation, orientation angle θ, haze, light transmittance at a wavelength of 380 nm, bending resistance, and chemical resistance, by the aforementioned methods.

(7-5. Production of Polarizing Plate 7)

A polarizing plate 7 was produced in the same manner as that in step (1-5) of Example 1, except that the optical layered body 7 obtained in (7-4) was used in place of the optical layered body 1. A durability test was performed for the obtained polarizing plate 7 by the aforementioned method.

(7-6. Production of Liquid Crystal Display Device 7)

A liquid crystal display device 7 was produced in the same manner as that in step (1-6) of Example 1, except that the polarizing plate 7 was used in place of the polarizing plate 1. The obtained liquid crystal display device 7 was evaluated for its display quality by the aforementioned method.

### Comparative Example 1

(C1-1. Extrusion Step)

A pre-stretch layered body 8 which included the first surface layer (thickness: 4.0 μm) formed of the crystallizable resin K1/the substrate layer (thickness: 32.0 μm) formed of the crystallizable resin K1/the second surface layer (thickness: 4.0 μm) formed of the crystallizable resin K1 in this order was obtained in the same manner as that in step (1-3) of Example 1, except that the crystallizable resin K1 was used in place of the amorphous resin H1.

(C1-2. Stretching Step)

An optical layered body 8 which included the first surface layer (thickness: 2.5 μm) formed of the crystallizable resin K1/the substrate layer (thickness: 20.0 μm) formed of the crystallizable resin K1/the second surface layer (thickness: 2.5 μm) formed of the crystallizable resin K1 in this order was obtained in the same manner as that in step (1-4) of Example 1, except that the pre-stretch layered body 8 was used in place of the pre-stretch layered body 1. The optical layered body 7 was evaluated for its in-plane retardation, orientation angle θ, haze, light transmittance at a wavelength of 380 nm, bending resistance, and chemical resistance, by the aforementioned methods.

(C1-3. Production of Polarizing Plate 8)

A polarizing plate 8 was produced in the same manner as that in step (1-5) of Example 1, except that the optical layered body 8 was used in place of the optical layered body 1. A durability test was performed for the obtained polarizing plate 8 by the aforementioned method.

(C1-4. Production of Liquid Crystal Display Device 8)

A liquid crystal display device 8 was produced in the same manner as that in step (1-6) of Example 1, except that the polarizing plate 8 was used in place of the polarizing plate 1. The obtained liquid crystal display device 8 was evaluated for its display quality by the aforementioned method.

### Comparative Example 2

(C2-1. Extrusion Step)

A pre-stretch layered body 9 which included the first surface layer (thickness: 4.0 μm) formed of the amorphous resin H2/the substrate layer (thickness: 32.0 μm) formed of the amorphous resin H2/the second surface layer (thickness: 4.0 μm) formed of the amorphous resin H2 in this order was obtained in the same manner as that in step (1-3) of Example 1, except that the amorphous resin H2 was used in place of the crystallizable resin K1 and the amorphous resin H1.

(C2-2. Stretching Step)

An optical layered body 9 which included the first surface layer (thickness: 2.5 μm) formed of the amorphous resin H2/the substrate layer (thickness: 20.0 μm) formed of the amorphous resin H2/the second surface layer (thickness: 2.5 μm) formed of the amorphous resin H2 in this order was obtained in the same manner as that in step (1-4) of Example 1, except that the pre-stretch layered body 9 was used in place of the pre-stretch layered body 1. The optical layered body 9 was evaluated for its in-plane retardation, orientation angle θ, haze, light transmittance at a wavelength of 380 nm, bending resistance and chemical resistance, by the aforementioned methods.

(C2-3. Production of Polarizing Plate 9)

A polarizing plate 9 was produced in the same manner as that in step (1-5) of Example 1, except that the optical layered body 9 was used in place of the optical layered body 1. A durability test was performed for the obtained polarizing plate 9 by the aforementioned method.

(C2-4. Production of Liquid Crystal Display Device 9)

A liquid crystal display device 9 was produced in the same manner as that in step (1-6) of Example 1, except that the polarizing plate 9 was used in place of the polarizing plate 1. The obtained liquid crystal display device 9 was evaluated for its display quality by the aforementioned method.

[Results]

The results of the aforementioned Examples and Comparative Examples are shown in Table 1 below. In the table, abbreviations mean as follows.

H1: amorphous resin H1

H2: amorphous resin H2

H3: amorphous resin H3

K1: crystallizable resin K1

Re: in-plane retardation of optical layered body

θ: orientation angle of optical layered body relative to longitudinal direction of optical layered body

Transmittance: light transmittance of optical layered body at a wavelength of 380 nm

Haze: haze of optical layered body

Display quality: display quality of liquid crystal display device

Bending resistance: bending resistance of optical layered body

Chemical resistance: chemical resistance of optical layered body

Durability: durability of polarizing plate

TABLE 1
[Results of Examples and Comparative Examples]

| | | | | | | | | | Comp. | Comp. |
|---|---|---|---|---|---|---|---|---|---|---|
| | | Ex. 1 | Ex. 2 | Ex. 3 | Ex. 4 | Ex. 5 | Ex. 6 | Ex. 7 | Ex. 1 | Ex. 2 |
| Substrate | Resin | H1 | H2 | H1 | H2 | H2 | H2 | H3 | K1 | H2 |
| layer | Amount of | 7 | 0 | 7 | 0 | 0 | 0 | 7 | 0 | 0 |
| | UV absorber | | | | | | | | | |
| | (%) | | | | | | | | | |
| | Thickness | 20.0 | 20.0 | 20.0 | 20.0 | 10.0 | 25.0 | 20.0 | 20.0 | 20.0 |
| | (μm) | | | | | | | | | |
| First | Resin | K1 | K1 | K1 | K1 | K1 | K1 | K1 | K1 | H2 |
| surface | Thickness | 2.5 | 2.5 | 2.5 | 2.5 | 7.5 | 0.05 | 2.5 | 2.5 | 2.5 |
| layer | (μm) | | | | | | | | | |
| Second | Resin | K1 | K1 | K1 | — | K1 | K1 | K1 | K1 | H2 |
| surface | Thickness | 2.5 | 2.5 | 2.5 | — | 7.5 | 0.05 | 2.5 | 2.5 | 2.5 |
| layer | (μm) | | | | | | | | | |

| | | | | | | | | | |
|---|---|---|---|---|---|---|---|---|---|
| Total thickness (μm) | 25.0 | 25.0 | 25.0 | 22.5 | 25.0 | 25.1 | 25.0 | 25.0 | 25.0 |
| Re (nm) | 140 | 160 | 5 | 140 | 250 | 130 | 380 | 800 | 150 |
| θ (°) | 42 | 42 | 0.5 | 44 | 40 | 45 | 43 | 39 | 45 |
| Transmittance (λ = 380 nm (%)) | 0.06 | 89.5 | 0.06 | 90.1 | 88.9 | 90.1 | 0.06 | 87.9 | 90.5 |
| Haze (%) | 0.1 | 0.1 | 0.08 | 0.08 | 0.5 | 0.04 | 0.3 | 1.0 | 0.01 |
| Display quality | 3 | 3 | 2 | 3 | 2 | 3 | 2 | 1 | 3 |
| Bending resistance | 3 | 3 | 2 | 3 | 2 | 2 | 4 | 3 | 1 |
| Chemical resistance | 3 | 3 | 2 | 3 | 3 | 2 | 4 | 3 | 1 |
| Durability | 3 | 2 | 3 | 2 | 2 | 2 | 3 | 3 | 1 |

### DISCUSSION

As understood from Table 1, in Examples, favorable results for all of the bending resistance and chemical resistance of the optical layered body as well as the display quality of the liquid crystal display device are successfully obtained. The bending resistance and chemical resistance are further enhanced when the heating step is performed after the stretching step. Thus, it was confirmed that, according to the present invention, there can be achieved an optical layered body which allows a liquid crystal display device to have a favorable display quality when viewed through polarized sunglasses and which is excellent in chemical resistance and bending resistance.

1. An optical layered body comprising a substrate layer and a first surface layer, wherein
the substrate layer includes a polymer containing an amorphous alicyclic structure, and
the first surface layer includes a polymer containing a crystallizable alicyclic structure.

2. The optical layered body according to claim 1, wherein
the optical layered body has a retardation of 400 nm or less, and
the first surface layer has a thickness of 0.1 μm to 5.0 μm.

3. The optical layered body according to claim 1, wherein the polymer containing a crystallizable alicyclic structure is a hydrogenated product of a ring-opened polymer of dicyclopentadiene.

4. The optical layered body according to claim 1, wherein the optical layered body has a transmittance at a wavelength of 380 nm of 10% or less.

5. The optical layered body according to claim 1, further comprising a second surface layer on the substrate layer opposite the first surface layer, wherein
the second surface layer includes a polymer containing a crystallizable alicyclic structure.

6. The optical layered body according to claim 1, wherein
the optical layered body has a long-length shape, and
a slow axis of the optical layered body is neither parallel to nor perpendicular to a longitudinal direction of the optical layered body.

7. The optical layered body according to claim 6, wherein an orientation angle relative to the longitudinal direction of the optical layered body is 45°±5°.

8. A polarizing plate comprising the optical layered body according to claim 1 and a polarizer.

9. A liquid crystal display device comprising the polarizing plate according to claim 8.
